(19) United States
(12) Patent Application Publication
(10) Pub. No.: US 2024/0368734 A1
(43) Pub. Date: Nov. 7, 2024

(54) METHODS FOR EXTRACTING RARE EARTH ELEMENTS FROM RARE EARTH ELEMENT SOURCES

(71) Applicant: VIRGINIA TECH INTELLECTUAL PROPERTIES, INC., Blacksburg, VA (US)

(72) Inventors: Roe-Hoan YOON, Blacksburg, VA (US); Christopher Aaron NOBLE, Blacksburg, VA (US); Roberto McAlister COUNCIL-TROCHE, Radford, VA (US); Wei LIU, Blacksburg, VA (US)

(21) Appl. No.: 18/255,665

(22) PCT Filed: Dec. 4, 2021
(86) PCT No.: PCT/US21/61917

§ 371 Date: Jun. 2, 2023

Related U.S. Application Data
(60) Provisional application No. 63/121,435, filed on Dec. 4, 2020.

(51) Int. Cl. C22B 59/00; C22B 1/14; C22B 3/12; C22B 3/22; C22B 3/42

(52) U.S. Cl. CPC C22B 59/00; C22B 1/14; C22B 3/12; C22B 3/22; C22B 3/42

(57) ABSTRACT

Described herein are methods for methods for extracting earth elements from rare earth element sources. In one aspect, the rare earth element source includes clayey materials present in coal and coal by-products, where one or more rare earth elements are adsorbed on the clayey materials. The methods involve admixing the rare earth element source with a base and an electrolyte composition. In one aspect, the electrolyte composition includes a chelating agent and/or a complexing agent. The extraction process is conducted at temperatures less than or equal to 100° C., which makes the process cost-effective and sustainable.

### CROSS-REFERENCE TO RELATED APPLICATIONS

This application claims the benefit of and priority to co-pending U.S. Provisional Patent Application No. 63/121,435, filed on Dec. 4, 2020, the contents of which are incorporated by reference herein in their entireties.

### STATEMENT REGARDING FEDERALLY SPONSORED RESEARCH OR DEVELOPMENT

This invention was made with government support under grant number DE-FE0029900, awarded by the US Department of Energy. The government has certain rights in the invention.

### BACKGROUND

In 2019, the global mine production of rare earth oxides (REOs) was 210,000 metric tons (MT), of which China accounted for 62.9%, followed by the U.S. (12.4%), Burma (10.5%), Australia (10.0%), and others (4.2%) (Mineral Commodity Summary, 2020). Since the U.S. production went to China for its lax environmental regulations for processing, one country is now controlling 75.3% of the global production of the materials that are critical to national security.

A source of rare earth elements (REEs) is coal and coal byproducts. Extracting rare earth elements from these resources is difficult for several reasons. The most difficult challenge is the low contained values associated with the low head grades, which limit viable options. The REE grades of these non-conventional resources are well below the cutoff grades of the conventional resources mined at the Mountain Pass Mine, CA, and the Bayan Obo Mine, China. Another challenge in extracting REEs from the non-conventional resources is that these critical elements are not in easily-extractable forms. The REEs present in fly ash as an example are usually encapsulated in glassy materials, which are difficult to crack open without employing large amounts of aggressive chemicals. For another, the rare earth minerals (REMs) found in coal byproduct (or refuse materials) are usually smaller than 10 μm in size, which makes it difficult to recover by flotation, which is the best available method of recovering mineral fines in industry. Under these constraints, developing efficient chemical extraction methods is imperative for extracting REEs from the domestic resources to minimize the foreign dependency of the critical materials.

### SUMMARY

Described herein are methods for extracting REEs from the coal and coal byproducts and other conventional resources. In one aspect, the rare earth element source is the clayey materials present in these resources, where one or more rare earth elements are intimately associated with the clayey materials. The new methods in the instant invention involve admixing the rare earth element source with a base (or alkali) and an electrolyte composition. In one aspect, the electrolyte composition includes chelating and/or complexing agents. The extraction process is conducted at temperatures less than or equal to 100° C., which makes the process cost-effective with respect to energy consumption, minimizes wastewater generation, and thereby increases its sustainability.

The advantages of the invention will be set forth in part in the description which follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate several aspects described below:

FIGS. 1A-1B show exemplary flowsheets for rare earth element recovery from a thickener underflow and fine coal refuse.

FIG. 2 shows the results obtained on the blunged clays from the Fire Clay and Lower Kittanning coal refuse from thickener underflows.

FIG. 3 shows the stability diagram for the La³⁺—PO⁴⁻—H₂O system at [La³⁺] and [PO₄³⁻]=10⁻⁵ M.

FIG. 4 shows the stability diagram for the La³⁺—H₂O system at [La³⁺]=10⁻⁵ M and [PO₄³⁻]=0, in which La(OH)₃(cr) represents lanthanum hydroxide crystal or solid.

FIG. 5 shows that LaPO₄(s) becomes soluble in the presence of small amounts of EDTA at any pH.

FIG. 6 shows the effect of EDTA on the dissolution of LaPO₄(s) at 80° C. at various pH.

FIG. 7 shows the effect of EDTPO on the extraction of REEs from the clay samples isolated from the Lower Kittanning coal refuse from a thickener underflow at 80° C.

FIGS. 8A-8B show the results of ion-exchange leaching of monazite (d₈₀=14.61 μm) at 0.5 M (NH₄)₂SO₄ and pH 4.0 after the NaOH pretreatment at 10, 30, and 50% concentration and 80° C. for 24 hrs; (a) total REE recovery, (b) element-by-element recoveries.

FIG. 9 shows XRD spectra of i) untreated monazite of d₈₀=14.61 μm, ii) monazite pretreated in a 30% NaOH solution at 80° C. for 24 hrs, and iii) of leach residue. The second spectrum shows hydroxide formation, which disappears after the ammonium sulfate leaching. The third spectrum shows the reappearance of the monazite substrate after the hydroxide leaching.

FIG. 10 shows Ce 3d XPS spectra of i) untreated monazite of d₈₀=14.61 μm (top spectrum); ii) NaOH-pretreated monazite (middle spectrum) at 30% NaOH and 80° C. for 24 hrs; iii) leach residue (bottom spectrum).

FIGS. 11A-11B show the effect of particle size on a) TREE recoveries, and b) individual REE recoveries. Monazite particles were pretreated in a 50% NaOH solution at 80° C. for 24 hrs, followed by (NH₄)₂SO₄ leaching at pH 4 and 25° C. for 2 hrs.

FIGS. 12A-12B show the comparison between extracting REEs from the NaOH pretreated monazite (d₈₀=14.61 μm) at 80° C., followed by (NH₄)₂SO₄ leaching at pH 4 and 25° C. and by acid leaching in a 6 M HCl solution; (a) TREE recoveries; (b) corresponding individual REE recoveries.

FIGS. 13A-13B show the total REE recovery (a) and individual REE recovery (b) of NaOH-treated monazite (50% NaOH, 80° C., 24 h, d₈₀=14.61 μm) leached by 0.5 M (NH₄)₂SO₄ at pH 4 as a function of leaching temperature.

FIG. 14 shows the total REE recovery leached by various sulfate-based lixiviants at pH 4 after 30% NaOH pretreatment at 80° C. for 24 h, d₈₀=14.61 μm.

FIG. 15 shows the total REE recovery of monazite leached by HCl at different pH values after 30% NaOH pretreatment at 80° C. for 24 h, d₈₀=14.61 μm.

FIG. 16 shows the effect of different anions of ammonium salts on the total REE recovery from monazite after NaOH pretreatment (30%) at 80° C. for 24 h, d₈₀=14.61 μm.

FIG. 17 shows the distribution diagram of the species derived from La(OH)₃(s) in water at 25° C.

FIG. 18 shows the zeta potentials of the NaOH-treated monazite (d₈₀=14.61 μm) at pH 4 and in the presence of 0.5 M (NH₄)₂SO₄ at pH 4.0 and 6.7.

FIG. 19 shows the proposed ion-exchange mechanism for the leaching of Ln(OH)₃(s) using (NH₄)₂SO₄ as lixiviant.

### DETAILED DESCRIPTION

Many modifications and other embodiments disclosed herein will come to mind to one skilled in the art to which the disclosed compositions and methods pertain to having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a rare earth element” includes, but is not limited to, mixtures or combinations of two or more such elements.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “rare earth element” is defined as any element that includes one or more of the 15 lanthanide elements, scandium or yttrium. The 17 rare-earth elements are cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb), and yttrium (Y). They are often found in minerals with thorium (Th), and uranium (U). Rare earth elements generally exist as minerals in nature. In one aspect, the rare earth element is a rare earth phosphate, formate, carbonate, chloride, oxide, or hydroxide.

As used herein, the term “admixing” is defined as mixing two or more components together so that there is no chemical reaction or physical interaction. The term “admixing” also includes the chemical reaction or physical interaction between the two or more components.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e. one atmosphere).

Described herein are methods for methods for extracting earth elements from rare earth element sources. Details for performing the methods described herein are provided below.

### Extraction of Rare Earth Elements

The methods described herein provide a low-cost, environmentally benign, process for extracting rare earth elements from rare earth element sources. The general approach involves converting insoluble rare earth elements that are in insoluble forms can be readily extracted or removed from the rare earth element sources. In one aspect, the methods involve admixing the rare earth element source with a base and an electrolyte composition comprising a plurality of cations, anions, or a combination thereof. In one aspect, the electrolyte composition includes chelating and/or complexing agents.

The order in which a rare earth element source can be admixed with the base and an electrolyte composition can vary. In one aspect, the rare earth element source can be first admixed with the base to produce a first composition followed by admixing the first composition with the electrolyte composition. In another aspect, the rare earth element source can be first admixed with the electrolyte composition to produce a first composition followed by admixing the first composition with the base. In another aspect, the rare earth element source is admixed with a composition comprising the base and the electrolyte composition.

In one aspect, the method for extracting one or more rare earth elements from a rare earth element source comprises
a. admixing the rare earth element source in water with a base at temperature less than or equal to 100° C. to produce a first composition;
b. admixing the first composition with an electrolyte composition comprising a plurality of cations, anions, or a combination thereof to produce a second composition; and
C. extracting the rare earth elements from the second composition.

An advantage of extracting rare earth elements at temperatures below the boiling point of water is to obviate the need to use pressurized reactors and thereby minimize the capital cost for building an extraction plant.

In another aspect, the method for extracting one or more rare earth elements from a rare earth element source comprises
a. admixing the rare earth element source in water with an electrolyte composition comprising a plurality of cations, anions, or a combination thereof at temperature less than or equal to 100° C. to produce a first composition;
b. admixing the first composition with a base to produce a second composition; and
c. extracting the rare earth element from the second composition.

In another aspect, the method for extracting one or more rare earth elements from a rare earth element source comprises
a. admixing the rare earth element source in water with (i) a base and (ii) an electrolyte composition comprising a plurality of cations, anions, or a combination thereof at temperature below 100° C. to produce a first composition; and
b. extracting the rare earth element from the first composition.

Upon admixing the rare earth element source with the base, insoluble forms of rare earth elements are converted to soluble compounds. In one aspect, rare earth phosphates can be converted to rare earth oxides, hydroxides and/or oxyhydroxides upon reaction with the base. In one aspect, the base comprises an alkali metal hydroxide, ammonium hydroxide, or a combination thereof. In another aspect, the base comprises sodium hydroxide, potassium hydroxide, sodium carbonate, lime, or any combination thereof.

In one aspect, the rare earth element source is pulverized to produce smaller particles prior to step (a) of the methods described herein. Not wishing to be bound by theory, reducing the particle size of the rare earth element source can increase the efficiency of the methods described herein (e.g, reduce the temperature or concentration of acid or base needed). The rare earth element source can be pulverized using techniques known in the art and can be performed by a batch or continuous process. In one aspect, the rare earth element source has an average particle size of less than about 100 μm, or about 1 μm, 2 μm, 4 μm, 6 μm, 8 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, or 100 μm, where any value can be a lower and upper end-point of a range (e.g., about 1 μm to about 20 μm).

In one aspect, the base is an aqueous composition when admixed with the rare earth element source. In another aspect, an aqueous base composition is admixed with an aqueous composition composed of the rare earth element source. The amount of base used can vary depending upon the amount of rare earth element adsorbed on the rare earth element source. In one aspect, the base is from about 1% to about 80% by volume of the first composition (i.e., composition composed of rare earth element source and base), or is from about 1%, about 5%, about 10%, about 15%, about 20%, about 25%, about 30%, about 35%, about 40%, about 45%, about 50%, about 55%, about 60%, about 65%, about 70%, about 75%, or about 80%, where any value can be a lower and upper end-point of a range (e.g., about 15% to about 35%). In another aspect, the concentration of the base can vary. In one aspect, the concentration of the base can be from about 0.1 M to 5 M, or about 0.1 M, about 0.5 M, about 1.0 M, about 1.5 M, about 2.0 M, about 2.5 M, about 3.0 M, about 3.5 M, about 4.0 M, about 4.5 M, or about 5.0 M, where any value can be a lower and upper end-point of a range (e.g., about 1 M to about 3 M). In certain aspects, higher concentrations of base can be used, where the base can be recycled using standard industry techniques.

In addition to the base (or alkali) treatment, the rare earth element sources are contacted with an electrolyte composition in order to extract the rare earth elements from the rare earth element source. Not wishing to be bound by theory, the electrolyte solution containing the cations and/or anions can readily destabilize and decompose the rare earth element source to allow for the rare earth elements to be extracted from the source. The use of the electrolyte solution in combination with the base enhances the decomposition and the subsequent removal of the rare earth elements from the rare earth element sources. For example, lower amounts of base are required when used in combination with the electrolyte composition, which ultimately reduces the cost of the extraction process. The electrolyte source includes chelating agents and/or complexing agents. Additionally, the process does not require the use of strong acids previously used in the extraction of rare earth elements. Here, the use of strong acids results in the generation of large amounts of wastewater.

In one aspect, the electrolyte composition comprises a chelating agent. A chelating agent is any molecule that forms two or more coordination bonds with the rare earth element. For example, the chelating agent can be an organic molecule with two amine groups, where each amine group can form a coordination bond with a rare earth ion (e.g., a lanthanide ion Ln³⁺). In one aspect, the chelating agent can be a bidentate ligand, a tridentate ligand, a tetradentate ligand, a pentadentate ligand, a hexadentate, or an octadentate ligand.

In one aspect, the chelating agent comprises a phosphoric acid (i.e., an organic compound with two or more phosphoric acid groups), a phosphonic acid, an organic acid (i.e., an organic compound with two or more carboxylic acid groups), a diamine (i.e., an organic compound with two amine groups), a polyamine (i.e., an organic compound with three or more amine groups), a hydroxamic acid, a polyol (i.e., an organic compound with two or more hydroxyl groups), a sulfonic acid (i.e., an organic compound with two or more sulfonic acid groups), or any combination thereof.

In another aspect, the chelating agent can be one or more of the following compounds: acetylacetone, alizarin, amidoxime, aminoethylethanolamine, aminomethylphosphonic acid, aminopolycarboxylic acid, ATMP, aza-crown ether, BAPTA, bathocuproine, BDTH2, benzotriazole, benzoylacetone, bipyridine, 2,2′-bipyridine, 2,2′-Bipyrimidine, bis(dicyclohexylphosphino) ethane, 1,2-bis(dimethylarsino) benzene, 1,2-bis(dimethylphosphino) ethane, 1,4-bis(diphenylphosphino) butane, 1,2-bis(diphenylphosphino) ethane, calixarene, carcerand, catechol, cavitand, citrate, citric acid, clathrochelate, corrole, cryptand, 2.2.2-cryptand, cyclam, cyclen, cyclodextrin, deferasirox, deferiprone, deferoxamine, dexrazoxane, diacetyl monoxime, trans-1,2-diaminocyclohexane, 1,2-diaminopropane, 1,5-diaza-3,7-diphosphacyclooctanes, 1,4-diazacycloheptane, 1,5-diazacyclooctane, dibenzoylmethane, diethylenetriamine, diglyme, 2,3-dihydroxybenzoic acid, dimercaprol, 2,3-dimercapto-1-propanesulfonic acid, dimercaptosuccinic acid, 1,1-dimethylethylenediamine, 1,2-dimethylethylenediamine, dimethylglyoxime, DIOP, diphenylethylenediamine, 1,5-dithiacyclooctane, domoic acid, DOTA (chelator), DOTA-TATE, DTPMP, EDDHA, EDDS, EDTA, EDTMP, EGTA, 1,2-ethanedithiol, ethylenediamine, ethylenediaminediacetic acid, ethylenediaminetetraacetic acid, etidronic acid, Fluo-4, Fura-2, gallic acid, gluconic acid, glutamic acid, glyoxal-bis(mesitylimine), glyphosate, hexaaza-18-crown-6, hexafluoroacetylacetone, homocitric acid, hydroxyethylethylenediaminetriacetic acid, iminodiacetic acid, indo-1, isosaccharinic acid, kainic acid, nitrilotriacetic acid, oxalic acid, oxime, pendetide, penicillamine, pentetic acid, phanephos, phenanthroline, O-phenylenediamine, phosphonate, phthalocyanine, phytochelatin, picolinic acid, polyaspartic acid, porphine, 3-pyridylnicotinamide, 4-pyridylnicotinamide, pyrogallol, salicylic acid, sarcophagine, sodium citrate, sodium diethyldithiocarbamate, sodium polyaspartate, terpyridine, tetramethylethylenediamine, tetraphenylporphyrin, tetrasodium EDTA, thenoyltrifluoroacetone, thioglycolic acid, thujaplicin, TPEN, 1,4,7-triazacyclononane, tributyl phosphate, triethylenetetramine, 1,1,1-trifluoroacetylacetone, 1,4,7-trimethyl-1,4,7-triazacyclononane, triphos, trisodium citrate, 1,4,7-trithiacyclononane, or TTFA.

In one aspect, the electrolyte composition comprises a complexing agent. Complexing agents bind with the lanthanide ions in solution and thereby decrease the activities of the ions, causing the solubility of a rare earth resource in water to increase. In one aspect, the complexing agent is a Lewis base or a Bronsted base. Examples of complexing agent include, but are not limited to, amines (e.g., primary, secondary, or tertiary) and anions such as, for example, acetate ions, sulfate ions, formate ions, bicarbonate ions, carbonate ions, chloride ions, nitrate ions, pyrophosphate, or any combination thereof.

In another aspect, the electrolyte composition comprises a plurality of cations, anions, or a combination thereof. In one aspect, the electrolyte composition includes cations such as, for example, ammonium ions, aluminum ions, magnesium ions, sodium ions, cadmium ions, or any combination thereof. In another aspect, the electrolyte composition includes anions such as, for example, sulfate ions, formate ions, bicarbonate ions, carbonate ions, chloride ions, nitrate ions, pyrophosphate, or any combination thereof. In another aspect, the electrolyte composition includes ammonium sulfate, aluminum sulfate, magnesium sulfate, sodium chloride, sodium acetate, sodium pyrophosphate, sodium bicarbonate, ammonium formate, ammonium nitrate, or any combination thereof.

The concentration of the chelating agent and complexing agent can vary depending upon the amount of rare earth element source and base used. In one aspect, the chelating agent is from about 10 ppm to about 200 ppm by weight of the composition (e.g., composition composed of rare earth element source with or without base), or is from about 1 ppm, 5 ppm, 10 ppm, about 20 ppm, about 30 ppm, about 35 ppm, about 40 ppm, about 45 ppm, or about 50 ppm, where any value can be a lower and upper end-point of a range (e.g., about 10 ppm to about 100 ppm). In one aspect, the concentration of the chelating agent can be from about 5×10⁻⁷ M to 5×10⁻⁴ M, or about 0.01 M, about 0.05 M, about 0.1 M, about 0.2 M, about 0.3 M, about 0.4 M, about 0.5 M, about 1.0 M, about 1.5 M, or about 2.0 M, where any value can be a lower and upper end-point of a range (e.g., about 5×10⁻⁷ M to about 2.0 M).

As discussed above, the order in which the rare earth element source can be admixed with the base and the electrolyte composition can vary. The base and electrolyte composition (e.g., chelating agent) can be admixed sequentially or concurrently with the rare earth element source. In one aspect, the rare earth element source will exist as an aqueous (i.e., water-based) composition, to which are added aqueous compositions of the base and electrolyte composition sequentially or concurrently.

The pH of the process can vary depending upon the selection of the rare earth element source as well as the amounts of base and electrolyte composition used. In one aspect, when the electrolyte composition is added to the rare earth element source, the pH of the final composition can be in the range of about 3.0 to about 10, or about 3.0, about 3.5, about 4.0, about 4.5, about 5.0, about 5.5, about 6.0, about 6.5, about 7.0, about 7.5, about 8.0, about 8.5, about 9.0, about 9.5, or about 10, where any value can be a lower and upper end-point of a range (e.g., about 4 to about 8).

The temperature at which the methods described herein can vary. In one aspect, the rare earth element source is admixed with the base at a temperature less than or equal to 100° C., or about 20° C., 25° C., 30° C., 35° C., 40° C., 45° C., 50° C., 55° C., 60° C., 65° C., 70° C., 75° C., 80° C., 85° C., 90° C., 95° C., or 100° C., where any value can be a lower and upper end-point of a range (e.g., 70° C. to about 90° C.). In another aspect, the rare earth element source is admixed with the electrolyte composition (e.g., the chelating agent) at a temperature less than or equal to 100° C., or about 20° C., 25° C., 30° C., 35° C., 40° C., 45° C., 50° C., 55° C., 60° C., 65° C., 70° C., 75° C., 80° C., 85° C., 90° C., 95° C., or 100° C., where any value can be a lower and upper end-point of a range (e.g., about 60° C. to about 90° C.).

The duration of the admixing of the base and electrolyte composition with the rare earth element source can vary and be optimized accordingly. Techniques known in the art for performing the admixing steps can be used herein. The methods described herein can be performed in continuous or batch operations. The methods described herein do not require separate isolation steps after the additional of the base and electrolyte composition. For example, after the rare earth element source has been treated with the base, the base treated product is not subsequently processed to produce a solid form of the product (i.e., solvent such as water is not removed). When the amount of the base used during the pretreatment step is large, however, a small amount of acid may be added to bring the pH down to a slightly acidic range, e.g., pH 4 to 6, to maximize the efficiency of ion-exchange leaching. The steps of admixing the rare earth element source with the base and electrolyte composition are performed such that admixing occurs together without additional processing steps. In one aspect, the rare earth element source is admixed with the base from about 0.5 hours to about 48 hours, or about 0.5 hours, about 2 hours, about 6 hours, about 12 hours, about 18 hours, about 24 hours, about 30 hours, about 36 hours, about 42 hours, or about 48 hours, where any value can be a lower and upper end-point of a range (e.g., about 12 hours to about 24 hours).

After the rare earth element source has been admixed with the base and electrolyte composition such that the rare earth element source has been destabilized and/or decomposed, the rare earth source can release rare earth element into solution by the addition of an appropriate lixiviant and be subsequently isolated from the composition. In one aspect, the rare earth element can be isolated from the solution as precipitates from the composition by the addition of a precipitating agent.

There are many rare earth element sources in nature. In one aspect, wherein the rare earth element source comprises monazite, apatite, xenotime, bastnasite, an ion-adsorption clay, a secondary phosphate mineral, or any combination thereof.

In one aspect, the rare earth element source is a clayey material including an Ion adsorption clay. Ion adsorption clays are formed as a result of in-situ weathering of rare earth-rich host rocks such as granite. Clay minerals e.g., kaolinite, halloysite, etc., are made of layers of SiO₄ tetrahedra and AlO₄(OH)₂ octahedra. During the process of forming these minerals, part of the Si⁴⁺ and Al³⁺ ions in the cross-linked polyhedra are isomorphially are substituted by cations of lower formal charges, e.g., Si⁴⁺ by Al³⁺ and Al³⁺ by Mg²⁺ ions, causing the basal surfaces of the clay minerals to be net negatively charged when they are submersed in aqueous media. The lanthanide (Ln³⁺) ions in solution would adsorb on the negatively charged surfaces and enrich the clay minerals with rare earth ions by weak electrostatic forces.

There are three major ion-adsorption clay deposits known to date: i) South China, ii) Brazil, and iii) Madagascar in Africa. At present, the ion-adsorption clays in South China alone account for ˜80% of the world's heavy rare earth elements (HREEs) production. The decrease in production observed in recent years is due to the declining reserve base and the increased awareness of the environmental issues associated with the extraction of rare earth elements from ion-adsorption clay ores.

In another aspect, clayey materials present in coal and coal by-products can be the rare earth element source. As discussed above, extracting rare earth elements from coal and coal byproducts is difficult for various reasons. The most significant challenge is the low contained values due to their low head grades, which limit viable options. Another problem is that they are not in easily-extractable forms. The rare earth elements present in fly ash, for example, are usually encapsulated in glassy materials, requiring costly alkali cracking, flowed by acid-leaching processes. For another, the rare earth minerals (REMs) found in refuse materials are smaller than 10 μm, making it difficult to recover them by flotation—the standard separation method used in the minerals processing industry. Under these situations, recovery by chemical leaching may be the best option. However, chemical extraction processes are inherently costlier than physical extraction processes often by orders of magnitudes.

Coal by-products include clayey materials with REEs adsorbed to them. There are many advantages of extracting REEs from the clay minerals present in coal refuse. First, most of the REEs in coal are associated with clay minerals (Bryan et al., 2015). Second, Ln³⁺ ions are likely adsorbed on clay surfaces by the weak coulombic attraction or electrical double-layer (EDL) forces; therefore, less energy may be required to recover them by ion-exchange leaching than by using strong acids to break chemical bonds. Third, clay minerals constitute 60-70% of the mineral matter in coal (Renton, 1982). Fourth, clay minerals congregate to thickeners in coal cleaning plants, obviating the cost of remining. Fifth, the amounts of REEs that can be recovered from currently operating coal cleaning plants may exceed 50% of the domestic consumption. Sixth, the REEs extracted from clay are rich in HREEs and energy critical materials. Seventh, the amounts of radioactive elements, i.e., Th and U, are low. Eighth, the clay minerals are rich sources of yttrium (Y) and scandium (Sc) that command high prices. Ninth, the ion-exchange leaching process does not entail substantial dissolution of clayey materials, which will minimize the cost of effluent treatment. Tenth, processing thickener underflows will produce salable coal as byproducts. Finally, the reject materials the coal recovery step can be used as feedstocks using a low-cost physical separation process to obtain high-grade REM concentrates with high contained values that can be used as feedstocks for producing rare earth oxides and metals using the acid- or alkali-cracking and leaching processes that are more costlier than the simple ion-exchange leaching processes employed in South China.

The presence of ion-adsorption clays in US coals may be supported by the work reported by Foley et al. of USGS (2015a,b). These investigators showed that the climate and geological conditions of the Central Appalachia region and South China were similar, and that the REEs can be readily extracted using either by ion-exchange leaching or by using appropriate complexing agents. A major difference between the two sources of clay, i.e., coal and granite, may lie in the fact that the former had been immersed in aqueous phase during the geological time scale, while the latter had not. The rare earth ions present in water interact with the PO₄⁻ ions in solution and make it difficult to be extracted by ion-exchange leaching. Ion-exchange leaching is possible when lanthanide ions are fully hydrated or form outer-sphere complexes so that they are weakly adsorbed on clay mineral surfaces.

In one aspect, the clay material is an underclay, a parting, a shale, a tonstein, or an overburden. In another aspect, the clayey material is derived from fine coal refuse.

In another aspect, the rare earth element source includes monazite. Monazite is a reddish-brown phosphate mineral that contains rare-earth elements. Monazite contains higher concentrations of Ln³⁺ ions, particularly for HREEs, than bastnaesite, which may be attributed to the fact that PO₄³⁻ ions are stronger base than CO₃²⁻ ions. For example, monazite contains typically 19% Nd, 3% Sm, 1.7% Gd, and 0.5% Dy, while bastnaesite contains typically 13% Nd, 0.5% Sm, 0.15% Gd, and 0% Dy. Xenotime, another phosphate mineral, contains much higher HREE contents and its yttrium content is 60%.

Monazite is chemically resistant to chemical weathering and has high specific gravity (4.8-5.3). They are found, therefore, with other heavy minerals, e.g., ilmenite, rutile, and zircon in beach sands and placer deposits, which represent the largest source of monazite. This mineral contains higher concentrations of HREEs than bastnaesite as noted above but is more stable and hence is difficult to extract them into solution. Large monazite deposits are found in Australia, Brazil, India, Malaysia, South Africa, and the U.S. According to a USGS report (Van et al., 2019), monazite and xenotime-bearing placer deposits are found in the Atlantic coastal plain encompassing Maryland, Virginia, North and South Carolinas, Georgia, Florida, and Alabama.

Monazite concentrates contain 50-60% rare earth oxides in addition to 4-12% ThO₂ and 0.3-0.5% U. The radioactive elements and other impurities must be removed from leach liquor prior to solvent extraction. The methods described herein are effective in removing rare earth elements without considering removing radioactive elements such as thorium and uranium.

In another aspect, the rare earth element source includes other REE-bearing phosphate minerals such as apatite, xenotime, and the secondary phosphate minerals such as rhabdophane, crandallite, cerianite, etc. The instant invention discloses methods of extracting REEs from these refractory minerals that are resistant to chemical changes under mild conditions. The novel extraction methods can also be used for extracting REEs from other REMs such as bastnasite, allanite, zircon, etc.

In prior step (a), the rare earth element source can be subjected to one or more processing steps to separate rare earth minerals from the rare earth element source. In one aspect, a rare earth element source can be subjected to hydrophobic hydrophilic separation (HHS) processes prior to step (a) to separate one or more rare earth minerals from the rare earth element source. The hydrophobic hydrophilic separation (HHS) process is described in detail in U.S. Pat. No. 9,518,241), which is incorporated by reference in its entirety.

HHS is a method of cleaning fine particles, particularly hydrophobic particles such as coal, of its impurities in aqueous media and removing process water from products to the levels that can usually be achieved by thermal drying. A hydrophobic liquid is added to an aqueous medium, in which a mixture (or slurry) of hydrophobic and hydrophilic particles are suspended. The hydrophobic liquid is added under conditions of high-shear agitation to produce small droplets. As used herein, “high shear”, or the like, means a shear rate that is sufficient to form large and visible agglomerates, which is referred to phase inversion. Under conditions of high-shear agitation, oil breaks up into small droplets, which collide with the fine particles, and selectively form pendular bridges with neighboring hydrophobic particles, and thereby produce agglomerates of hydrophobic particles. The intensity of agitation required to form the agglomerates can vary depending on particle size, particle hydrophobicity, particle shape, particle specific gravity (S.G.), the type and amounts of hydrophobic liquid used, etc. Ordinarily, agglomerate formation typically occurs at impeller tip speeds above about 35 ft/s, preferably above about 45 ft/s, more preferably above about 60 ft/s. In certain embodiments, the aqueous slurry is subjected to a low-shear agitation after the high-shear agitation to allow for the agglomerates to grow in size, which will help separate the agglomerates from the hydrophilic particles dispersed in the aqueous phase.

The agglomerated hydrophobic particles are separated from the dispersed hydrophilic particles using a simple size-size separation method such as screening. At this stage, the agglomerates are substantially free of the hydrophilic particles, but still contain considerable amount of the process water entrapped in the interstitial spaces created between the hydrophobic particles constituting the agglomerates. The entrapped water also contains dispersed hydrophilic particles dispersed in it.

To remove the entrained water, additional hydrophobic liquid is added to the agglomerates to disperse the hydrophobic particles in the liquid. The dispersion liberates the entrapped process water and the hydrophilic particles dispersed in it from the agglomerates. The hydrophobic particles dispersed in the hydrophobic liquid are then separated from the hydrophobic liquid. The hydrophobic particles obtained from this final step are practically free of surface water and entrained hydrophilic particles. Typically, the amount of hydrophilic particles associated with the clean hydrophobic particles are less than 10% by weight, preferably less than about 7%, more preferably less than about 3%; and less than about 10% water, preferably less than about 7% water, more preferably less than about 5% water. The method is able to remove over 90% of hydrophilic particles from the hydrophobic particles, preferably 95%, more preferably 98%; and 95% of water from the hydrophobic particles, preferably 95%, more preferably 99%.

The hydrophobic-hydrophilic separation (HHS) process described above can also be used to separate one type of hydrophilic particles from another by hydrophobizing a selected component using an appropriate method of hydrophobizing the selected component. For example, HHS may be practiced for separating rare earth bearing minerals such as monazite, xenotime, bastnaesite, and ion-adsorption clays from barren minerals and coal.

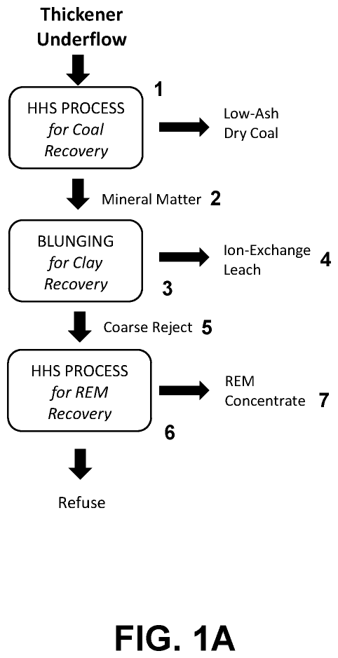

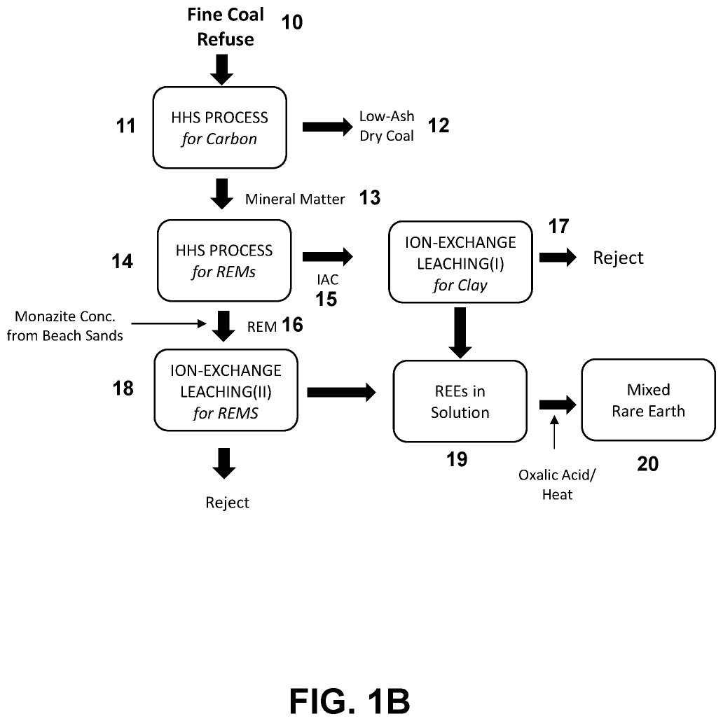

FIG. 1A shows a flowsheet that can be used to recover the rare earth-bearing minerals and compounds from a thickener underflow derived from a coal cleaning plant. Referring to FIG. 1A, in the first step 1, a salable coal will be produced as byproduct using the hydrophobic hydrophilic separation (HHS) process. The revenue stream from the coal sales can be substantial as approximately one-third of the solids reporting to a thickener underflow is recoverable coal. The mineral reject stream 2 from the coal recovery step is then blunged 3 to selectively isolate the clay minerals from other mineral matter (e.g., quartz, limestone, dolomite, etc.). The clay minerals in suspension will be subjected to ion-exchange leaching 4 to recover the rare earth elements. Ion-exchange leaching will be performed using the methods described herein to extract the rare earth elements from the clayey materials. The settled coarse reject 5 will then be attrition ground to liberate REMs 7 and recover them using the HHS process 6. The REMs that are too small to be recovered by physical separation methods such as flotation and/or the HHS process can also be subjected to the mild chemical treatment processes disclosed in the instant inventions to extract the rare earth elements.

FIG. 1B shows a flowsheet that can be used to recover the rare earth elements and compounds from fine coal refuse. Referring to FIG. 1B, in the first step, fine coal refuse 10 is subjected to a first hydrophobic hydrophilic separation (HHS) process 11 as described above, where low ash and dry salable coal 12 is produced. The mineral matter 13 (i.e., rare earth element source) is subjected to a second hydrophobic hydrophilic separation (HHS) process 14. In this step ion-adsorption clays (IAC 15) and rare earth minerals (REM 16) are separated from each other. Ion-exchange leaching will be performed on each of the IAC and REM (17 and 18) using the methods described herein to extract the rare earth elements into solution. The two streams of rare earth elements in solution are then combined (19) and subsequently isolated as mixed rare earth oxides (20) by precipitation with oxalic acid.

Depending upon the rare earth element source and condition used in the methods described herein, the isolated rare earth element can be one or more different compounds. In one aspect, the rare earth element that is isolated comprises a rare earth element metal ionic compound. In another aspect, the rare earth element that is isolated comprises a rare earth element salt, a rare earth element hydroxide, a rare earth element oxide, or a combination thereof. In another aspect, the rare earth element that is isolated comprises a rare earth element salt, a rare earth element hydroxide, or a rare earth element oxide of Ce, Nd, La, Sm, Pr, Gd, Y or any combination thereof.

### Aspects

The following listing of exemplary aspects supports and is supported by the disclosure provided herein.

Aspect 1. A method for extracting one or more rare earth elements from rare earth element source comprising
a. admixing the rare earth element source in water with a base at temperature less than or equal to 100° C. to produce a first composition;
b. admixing the first composition with an electrolyte composition comprising a plurality of cations, anions, or a combination thereof to produce a second composition; and
c. extracting the rare earth elements from the second composition.

Aspect 2. A method for extracting one or more rare earth elements from a rare earth element source comprising
a. admixing the rare earth element source in water with an electrolyte composition comprising a plurality of cations, anions, or a combination thereof at temperature less than or equal to 100° C. to produce a first composition;
b. admixing the first composition with a base to produce a second composition; and
c. extracting the rare earth elements from the second composition.

Aspect 3. A method for extracting one or more rare earth elements from a rare earth element source comprising
a. admixing the rare earth element source in water with (i) a base and (ii) an electrolyte composition comprising a plurality of cations, anions, or a combination thereof at temperature below 100° C. to produce a first composition; and
b. extracting the rare earth elements from the first composition.

Aspect 4. A method for extracting one or more rare earth elements from a rare earth element source comprising
a. admixing the rare earth element source in water with an electrolyte composition comprising a plurality of cations, anions, or a combination thereof at temperature below 100° C. to produce a first composition; and
b. extracting the rare earth elements from the first composition.

Aspect 5. The method of any one of Aspects 1 to 4, wherein the second composition has a pH in the range of about 3.5 to about 10.

Aspect 6. The method of any one of Aspects 1 to 5, wherein the base comprises an alkali metal and/or ammonium hydroxide.

Aspect 7. The method of any one of Aspects 1 to 5, wherein the base comprises sodium hydroxide, potassium hydroxide, sodium carbonate, lime, or any combination thereof.

Aspect 8. The method of any one of Aspects 1 to 7, wherein the base is from about 5% to about 80% by volume of the first composition.

Aspect 9. The method of any one of Aspects 1 to 7, wherein the base is from about 10% to about 50% by volume of the first composition.

Aspect 9. The method of any one of Aspects 1 to 9, wherein the rare earth element source is admixed with the base from about 0.5 hours to about 48 hours.

Aspect 11. The method of any one of Aspects 1 to 10, wherein the electrolyte composition comprises ammonium ions, aluminum ions, magnesium ions, sodium ions, cadmium ions, or any combination thereof.

Aspect 12. The method of any one of Aspects 1 to 11, wherein the electrolyte composition comprises sulfate ions, nitrate ions, formate ions, carbonate ions, bicarbonate ions, chloride ions, or any combination thereof.

Aspect 13. The method of any one of Aspects 1 to 11, wherein the electrolyte composition comprises ammonium sulfate, aluminum sulfate, magnesium sulfate, sodium chloride, ammonium formate, ammonium nitrate, or any combination thereof.

Aspect 14. The method of any one of Aspects 1 to 13, wherein the electrolyte composition comprises a chelating agent, a complexing agent, or a combination thereof.

Aspect 15. The method of Aspect 14, wherein the chelating agent comprises a phosphoric acid, an organic acid, a diamine, a polyamine, a hydroxamic acid, a polyol, a sulfonic acid, or any combination thereof.

Aspect 16. The method of any one of Aspects 1 to 15, wherein the electrolyte composition is admixed with the rare earth element source at a pH of from about 3.5 to about 7.5.

Aspect 17. The method of any one of Aspects 1 to 16, wherein the rare earth element source is admixed with the electrolyte composition at a temperature less than or equal to 100° C.

Aspect 18. The method of any one of Aspects 1 to 16, wherein the rare earth element source is admixed with the electrolyte composition at a temperature from about 40° C. to less than or equal to 100° C.

Aspect 19. The method of any one of Aspects 1 to 18, wherein the rare earth element source is pulverized prior to step (a).

Aspect 20. The method of any one of Aspects 1 to 19, wherein the rare earth element source has an average particle size of less than about 100 μm. Aspect 21. The method of any one of Aspects 1 to 20, wherein the rare earth elements are extracted by leaching.

Aspect 22. The method of any one of Aspects 1 to 21, wherein the rare earth element source comprises a clay material.

Aspect 23. The method of Aspect 22, wherein the clay material comprises a coal byproduct.

Aspect 24. The method of Aspect 23, wherein the coal byproduct comprises an underclay, partings, a shale, a tonstein, or an overburden.

Aspect 25. The method of any one of Aspects 1 to 21, wherein the rare earth element source comprises monazite, apatite, xenotime, bastnasite, an ion-adsorption clay, a secondary phosphate mineral, or any combination thereof.

Aspect 26. The method of any one of Aspects 1 to 21, wherein the rare earth element source comprises a rare earth metal salt.

Aspect 27. The method of any one of Aspects 1 to 21, wherein the rare earth element source comprises a rare earth phosphate, carbonate, fluorocarbonate, oxide, hydroxide, or oxyhydroxide.

Aspect 28. The method of any one of Aspects 1 to 21, wherein the clayey material is derived from fine coal refuse.

Aspect 29. The method of any one of Aspects 1 to 28, wherein the rare earth element that is isolated comprises a rare earth element metal ionic compound.

Aspect 30. The method of any one of Aspects 1 to 28, wherein the rare earth element that is isolated comprises a rare earth element salt, a rare earth element hydroxide, a rare earth element oxide, or a combination thereof.

Aspect 31. The method of any one of Aspects 1 to 28, wherein the rare earth element comprises Ce, Nd, La, Sm, Pr, Gd, Dy, Y, Sc, or any combination thereof.

Aspect 32. The method of any one of Aspects 1 to 31, wherein the process is conducted by a continuous process.

Aspect 33. The method of any one of Aspects 1 to 31, wherein the process is conducted by a batch process.

Aspect 34. The method of any one of Aspects 1-33, wherein prior to step (a), the rare earth element source is subjected to one or more physical separation processes to separate one or more rare earth-bearing minerals and ion-adsorption clays from the rare earth element source.

Aspect 35. The method of aspect 34, wherein the rare earth mineral comprises monazite, apatite, xenotime, bastnasite, an ion-adsorption clay, a secondary phosphate mineral, or any combination thereof.

Aspect 36. The method of any one of Aspects 1-35, wherein the base is from about 1% to about 50% by volume of the first composition and the electrolyte is a lixiviant such as, for example, ammonium sulfate.

Aspect 37. A method for extracting one or more rare earth elements from fine coal refuse comprising coal fines, clayey materials, and rare earth minerals using the method comprising
a. extracting salable coal fines from the clayey materials and the rare earth minerals;
b. separating the clayey material from the rare earth materials; and
c. extracting the rare earth elements from the clayey materials using the method in any one of Aspects 1 to 21 with or without separating the rare earth minerals.

Aspect 38. A method of extracting one or more rare earth elements from the naturally occurring rare earth phosphates using the method in any one of Aspects 1 to 21.

Aspect 39. A method of extracting one or more rare earth elements from a rare earth element source using a complexing agent to decrease the activity of lanthanide ions and thereby increase the solubility of the rare earth element source in water.

Aspect 40. A method of extracting rare earth elements from the clayey materials isolated from coal byproducts comprising the following steps,
a. pretreatment with a 1 to 10% NaOH solution in the presence of a chelating gent to decompose the passivated forms of rare earth elements,
b. extracting the rare earth elements into solution using a lixiviant.

Aspect 41. A method of extracting rare earth elements from the clayey materials isolated from coal byproducts using the steps involving the following steps,
a. pretreatment in a 1 to 10% NaOH solution to decompose the rare earth phosphate formed during coal formation, and
b. allow the rare earth elements to be extracted into solution using a lixiviant.

### EXAMPLES

The following examples are put forth so as to provide those of ordinary skill in the art with a complete disclosure and description of how the compounds, compositions, and methods described and claimed herein are made and evaluated, and are intended to be purely exemplary and are not intended to limit the scope of what the inventors regard as their invention. Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. Numerous variations and combinations of reaction conditions (e.g., component concentrations, desired solvents, solvent mixtures, temperatures, pressures, and other reaction ranges and conditions) can be used to further optimize the reagent consumption while at the same time increase the extraction efficiency.

### Example 1

Extraction of Rare Earth Elements from Clayey Materials

It was initially hypothesized that the REE ions adsorbed on clay surfaces may be in colloidal form, possibly as (Fe, Ln) OOH, which cannot be extracted by simple ion-exchange leaching. It was found subsequently that the REEs in this form can be extracted by leaching them under reducing conditions, so that the colloidal particles dissolve in water without precipitating iron as Fe(OH)₃(s). This process, known as reductive leaching, worked reasonably well with some coal byproducts but not with many others.

As demonstrated by Bern et al., 2017, the HCl extraction of REEs decreased sharply with increasing phosphorus (P) content of the weathered product (regolith). Not wishing to be bound by theory, it is possible that the PO₄³⁻ ions form insoluble LnPO₄(s) (or rare earth phosphate) compounds, which makes it difficult to extract Ln³⁺ ions from clay surfaces by ion-exchange leaching. The minerals formed in this manner are referred to as secondary phosphate minerals, which include rhabdophane, cerianite, and crandallite (Sanematsu et al, 2015).

Thus, the PO₄³⁻ ions may act effectively as a passivating agent for the extraction of REEs from the surfaces of clay minerals in coal. It is possible to remove the passivating agent from the clay minerals found in coal and coal byproducts by treating them with a stronger base than the PO₄³⁻ ions. In the instant invention, the OH⁻ ions have been tested successfully as follows,

$${{LnPO}_{4} ( s ) + 3 {OH}^{-} \to Ln ( OH )}_{3} ( s ) + {PO}_{{4}^{3 -}} [ m ] \qquad [ 1 ]$$

in which OH⁻ ions displace the PO₄⁻ ions as the former is a stronger base.

Lanthanum hydroxide has the minimum solubilities at a pH range of 10 to 13. As the pH decreases below 10, the solubility begins to increase, releasing increased amount of various Ln-bearing species such as Ln³⁺, LnOH⁺, and Ln(OH)₂⁺ ions into solution, which in turn reach an equilibrium with the same species present on the clay mineral surfaces. The Ln³⁺ ions on the clay surfaces may then be removed via an ion-exchange mechanism as follows,

$${Ln ( OH )}_{3} ( s ) - {Ln}^{3 +} + 3 {NH}_{{4}^{+}} \to {Ln ( OH )}_{3} ( s ) - 3 {NH}_{{4}^{+}} + {La}^{3 +} \qquad [ 2 ]$$

which is akin to the ion-exchange mechanism for the extraction of Ln³⁺ ions from the ion-adsorption clay surfaces (Moldoveanu and Papangelakis, 2012).

The ion-exchange leaching of the ion-adsorption clay works well because the La³⁺ ions are present on the basal surfaces as fully-hydrated outer-sphere complexes so that they are weakly attracted to the surface via weak electrostatic interaction (Borst et al., 2020).

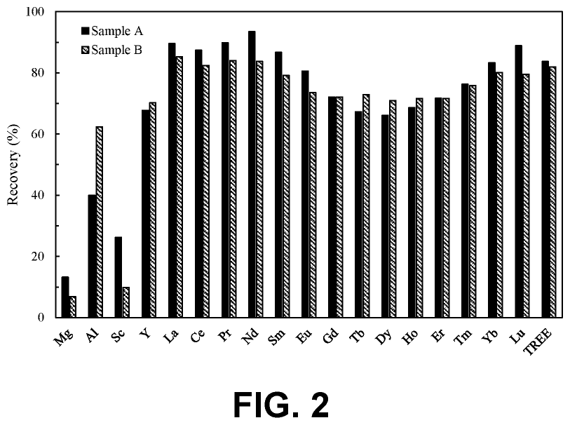

As has already been noted, the concentration of Ln³⁺ species should increase with decreasing pH below ˜10. Therefore, the ion-exchange leaching process (Reaction [2]) should become more efficient at a lower pH. The data presented in FIG. 2 have been obtained by ion-exchange leaching at pH 4 after a base treatment at a 50% NaOH at ˜125° C. The NaOH pretreatment step was necessary to overcome the passivating effect of the PO₄³⁻ ions noted above. The clay samples used in the extraction test were obtained by blunging the mineral reject materials obtained from the coal recovery step (FIG. 1). As shown, the extraction efficiencies varied with different REEs, with total REE recoveries being 77.7% and 83.7% for the clay samples isolated from the Fire clay and Lower Kittanning coal samples, respectively.

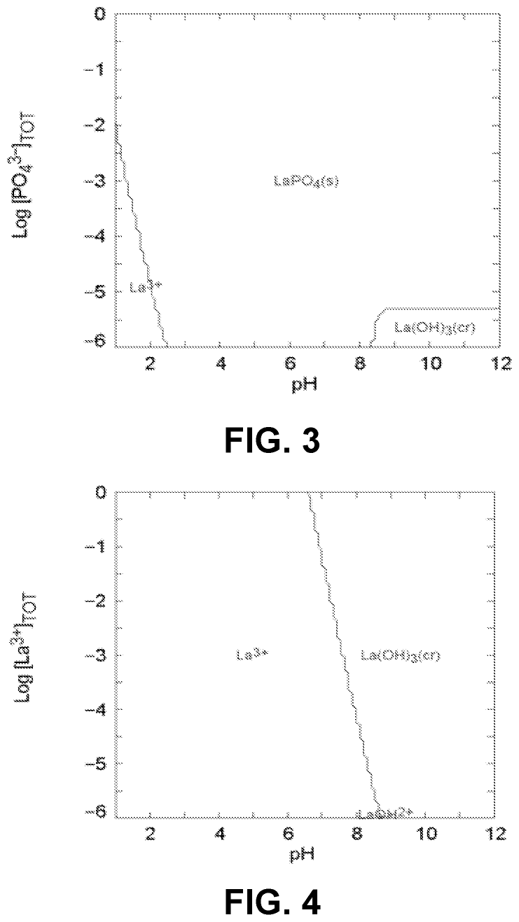

The different approaches described above are designed essentially to convert the lanthanide phosphate (LnPO₄) (s) formed as a result of passivation to Ln(OH)₃(s), which are more soluble. As shown in FIGS. 3 and 4, LaPO₄(s) is barely soluble even at very low pH and low PO₄³⁻ concentrations, while La(OH)₃(s) is soluble over a wide range of pH. The OH⁻ ions required for the conversion can be provided in the forms of NaOH, KOH, CaOH, and others. While the La(OH)₃(s) is acid soluble, it can also be dissolved by ion-exchange leaching at pH 4 to minimize acid consumption and thereby minimize waste water generation.

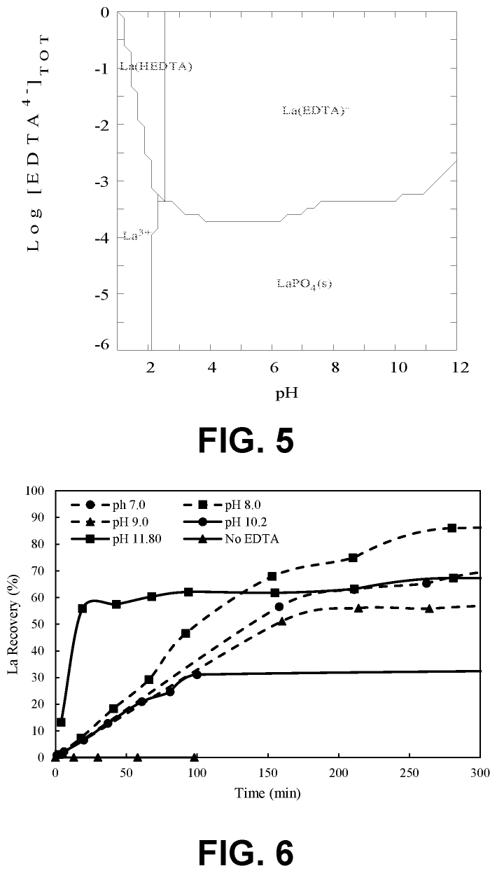

Another approach to overcome the harmful effect of the phosphate ions was to increase the solubility of LaPO₄(s)—passivated form of the REEs on clay surfaces—by adding a chelating agent to decrease the activities of the Ln³⁺ ions in solution so that the LaPO₄(s) dissolves beyond its solubility limit in water. FIG. 5 shows an example of using ethylenediaminetetraacetate (EDTA) as a chelating agent. As shown, La(PO₄)(s) should dissolve and release La³⁺ ions into water in the presence of the chelating agent.

In an effort to validate the simulation results given in FIG. 5, a neat LaPO₄(s) standard was purchased from a chemical company and subjected to a series of leaching experiments at 80° C. in the presence of 0.1 M EDTA. As shown in FIG. 6, LaPO₄(s) dissolved readily at pH 7.0 in the presence of the chelating agent.

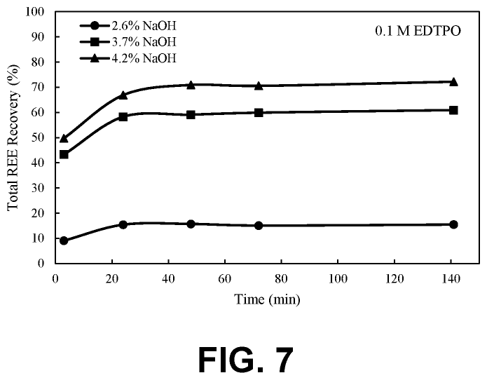

It has been demonstrated that a combination of the two different approaches described above, one to remove the passivating PO₄³⁻ ions and the other to use a chelating agent, were powerful tools to overcome the difficulties in extracting REEs from the surface of the clay minerals found in coal byproducts. FIG. 7 shows an example of using the two different approaches together on the clay minerals isolated by blunging a decarbonized thickener underflow sample taken from a coal preparation plant, West Virginia, in which a Lower Kittanning seam coal is processed. The clay samples were treated first with 2.6 to 4.6% NaOH (first approach), followed by leaching in 0.1 a M ethylenediaminetetra(methylenephophonic) acid (EDTPO)—a chelating agent—solution at 80° C. for different lengths of contact times (second approach). As shown, the recoveries were increased with increasing NaOH concentrations. The NaOH dosages employed in these experiments were not excessive.

### Leaching Monazite

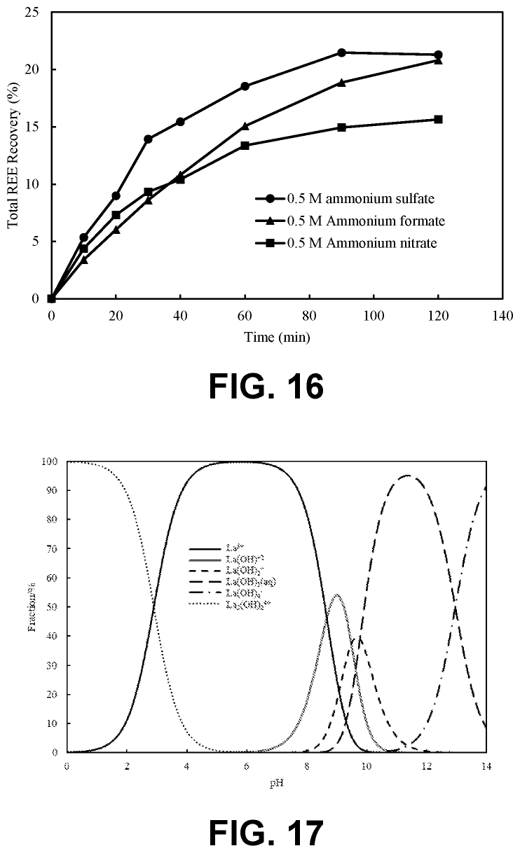

The novel methods of extracting rare earth elements from the ion-adsorption clays that have been passivated by phosphate ions can also be used to extract them from the natural monazite ((Ce,La,Nd)PO₄). Since monazite is a very stable compound, the mineral is treated under extremely harsh conditions, involving an acid digestion in a 98% H₂SO₄, solution at 200-220° C. (Gupta and Krishnamurthy, 2005). The results presented in FIG. 16 represent the results of the extraction tests conducted on a 75% pure monazite sample after a NaOH pretreatment step represented by Reaction [1], followed by the ion-exchange leaching step represented by Reaction [2]. In Step 1, the monazite sample was pretreated in a 30% NaOH solution at 80° C. for 24 hours. In Step 2, the pretreated monazite was subjected to an ion-exchange leaching step using ammonium sulfate, diethylamine, and ammonium formate as lixiviant, all at 0.5 M and pH 4. To facilitate the kinetics of the pretreatment and leaching steps, the monazite samples were finely ground to d₈₀=14.6 μm.

### Example 2

### Experimental

### Sample and Reagents

A Ce-type monazite, (Ce,La,Nd,Th)PO₄, sample assaying 24.3% total REE (TREE) and 2-3 inches in size was obtained from Khyber Mineral Co., Westmont, IL. The as-received sample was wet-ground in a ball mill to 80% passing (d₈₀) 14.6 μm, and the mill product was floated twice in a 4-L Denver laboratory flotation cell using potassium octyl hydroxamate as collector. A froth product assaying 48.9% TREE was obtained, which was equivalent to ˜75% monazite. Table 1 shows the elemental composition of the froth product.

TABLE 1
Elemental composition of the upgraded monazite sample

| Element | Grade(wt %) |
|---|---|
| Ce | 18.80 |
| Nd | 12.68 |
| La | 5.18 |
| Sm | 4.68 |
| Pr | 3.06 |
| Gd | 2.38 |
| Y | 1.49 |
| Other REEs | 0.66 |
| P | 9.57 |

The monazite concentrate obtained by flotation was dried in an oven and used for a series of leaching experiments. Part of the flotation product was ground to d₈₀=8.25 and 4.95 μm in a planetary ball mill for 1 and 2 hrs, respectively, for leaching tests. Monazite samples were analyzed by ICP-MC after digesting them at 1,000° C. in lithium metaborate and NaCO₃ as described by Larijani et al., (2016).

Reagent grade NaOH and HCl from Fisher Scientific were used for leaching experiments, while all other regents were of analytical grades. Deionized water with a resistivity of 18.2 MΩ·cm at 298.15 K was used in all solution preparation and leaching tests.

### Methods and Procedure

### NaOH Pretreatment

Monazite ((La,Ce)PO₄) is a salt of strong acids and strong base. Therefore, it takes a stronger base, e.g., OH⁻ ions, to disengage the PO₄³⁻ ions from the lanthanide (Ln³⁺) ions and decompose the mineral as follows,

$$Ln {PO}_{4} ( s ) + 3 \to {Ln ( OH )}_{3} ( s ) + 3 {Na}^{3 +} + {PO}_{{4}^{3 -}} \qquad [ 3 ]$$

to form Ln(OH)₃(s) on the surface, which is soluble in acid solutions. In the present work, a monazite sample ground to a desired particle size was pretreated in a NaOH solution before subjecting it to an ion-exchange leaching at pH 4.0 using (NH₄)₂SO₄ leaching as lixiviant. The pK_{b} values of PO₄³⁻ and OH⁻ ions are 1.7 and 0 to warrant the NaOH pretreatment step.

In each experiment, a 0.5 g monazite sample was mixed with 20 mL of a NaOH solution in a 50 mL alkali-resistant polytetrafluoroethylene (PTFE) beaker and heated on a hot plate at temperatures in the range of 60-80° C. for 24 hrs, while the mixture was being agitated at a 600 rpm by means of a Teflon-coated magnetic stir bar. The NaOH concentrations were varied in the range of 10⁻⁵⁰% w/v. The temperature of the sample suspension was monitored within ±1° C. by means of a temperature probe placed in the sample suspension. The beaker was covered with paraffin film to keep the evaporative loss water to less than 1 mL. The pretreated slurry was then subjected to solid-liquid separation by centrifugation at a 5,000 rpm for 10 mins. The residual NaOH was removed by re-pulping the residue with deionized water, followed by centrifugation. This process was repeated three times.

### Leaching Tests

The monazite samples pretreated with NaOH and water washed were subjected to a series of leaching experiments at room temperature using various lixiviants. In each test, 0.5 g of the sample was mixed with 40 mL of a lixiviant solution in a 50 mL polypropylene beaker. The slurry was then agitated magnetically for 2 hrs to provide adequate mixing. During leaching, aliquots of HCl and NaOH solutions both of 0.5 M were added to maintain the pH at 4.0±0.1. For the leaching experiments conducted at different temperatures, a Soxhlet extraction apparatus was used to minimize solvent loss.

Samples of the slurry were taken intermittently and analyzed for REEs to monitor the kinetics of leaching. After a given reaction time, 0.4 mL of the slurry was taken from the beaker by means of a 1 mL disposable syringe to be centrifuged at 3,000 rpm for 5 min for solid-liquid separation. The volume of the leach liquor taken at different times were measured by means of a 1 mL graduated cylinder, with each solution being diluted 2,000 times with a mixed HNO₃ (2.5%) and HCl (0.5%) solution for ICP-MS analysis. The recovery (R) of an REE species was determined using Eq. [2],

$$R = 100 \times \frac{{C}_{l} V}{{C}_{f} M} \qquad [ 4 ]$$

in which Cₗ and V are the REE concentration and volume of the leach liquor, respectively; and C_{f} and M are the REE concentration and weight of the monazite sample, respectively.

### ζ-Potential Measurements

Zeta-potential measurements were conducted on the monazite samples pretreated in a NaOH solution using the Malvern Zeta spectrometer (Model Zs90). The measurements were conducted in Nanopure water in the presence of 0.5 M (NH₄)₂SO₄ at pH 4.0 and 6.7. The monazite particles were coated with the Ln(OH)₃(s) formed by Reaction [1]. Therefore, the Zeta-potential measurement would give information on the ionic composition at the Ln(OH)₃(s)/(NH₄)₂SO₄ solution interface. The measurements were performed three times and the measured ζ-potentials were averaged.

### Powder X-Ray Diffraction Studies

The monazite samples treated with NaOH and subsequently with (NH₄)₂SO₄ were subjected to X-ray diffraction analysis using the Rigaku MiniFlex 600 XRD analyzer equipped with Cu-Kα radiation (λ=1.54 Å). The spectra were recorded over a 2θ range from 10⁻⁸⁰° with a step size of 0.04° and a dwell time of two seconds.

### X-Ray Photoelectron Spectroscopy Analysis

The samples and sample preparation method for XPS measurements were the same as those for the XRD analyses. A PHI VersaProbe Ill scanning XPS microscope, which was equipped with a monochromatic Al K-alpha X-ray source (1486.6 eV) with a base pressure of 3×10⁻⁸ Pa. As for the spectra, they were acquired over a 1,400 μm×100 μm with the settings of 100 μm/100 W/20 kV. The adventitious carbon peak at 248.8 eV was used as a reference for all binding energies.

### Results

### Ammonium Sulfate Leaching

### NaOH Pretreatment

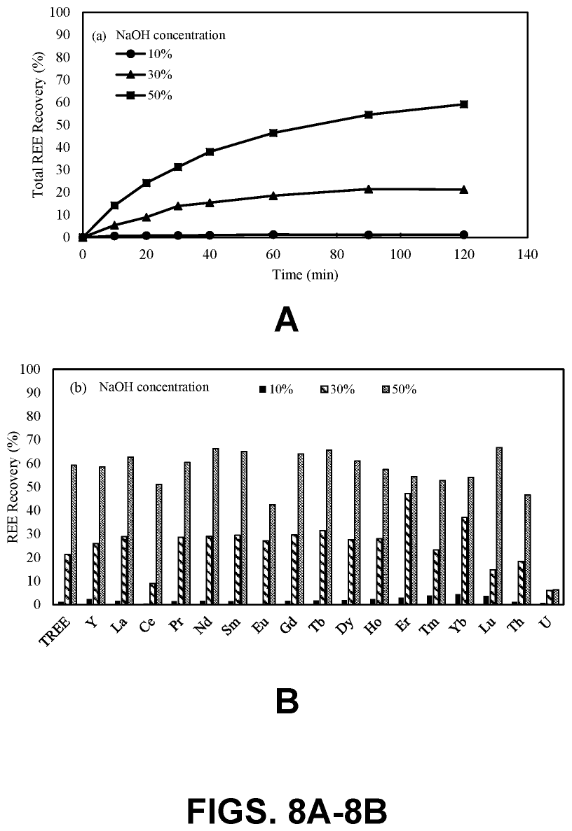

Rare earth extraction tests were conducted by agitating monazite samples in 10, 30, and 50% w/v NaOH solutions at 80° C. for 24 hrs. The pretreated samples were then placed in a 0.5 M (NH₄)₂SO₄ solution of pH 4.0 and agitated for 2 hrs at ambient temperature. The results presented in FIG. 8A to show that the REE recoveries increased with increasing NaOH concentration. The recovery was increased from 21 to 60% as the NaOH concentration was increased from 30 to 50% w/v. These results showed that it was necessary to displace the PO₄³⁻ ions by OH⁻ ions as suggested by Eq. [1] for monazite to be decomposed to form Ln(OH)₃(s), from which Ln³⁺ ions can be extracted by using (NH₄)₂SO₄ as lixiviant.

FIG. 8B shows the element-by-element REE recoveries obtained at 80° C. Despite the relatively mild operating conditions employed, the recoveries of the key elements were reasonably high: 66.3% Nd, 62.8% La, 61.0% Dy, 65.0% Sm, and 60.3% Pr. The Ce and Eu recoveries were lower as shown. The low Ce recoveries can be attributed to the oxidation of Ce(III) to Ce(IV) as will be shown later in conjunction with the XPS spectra. The low Eu recoveries may be attributed to the formation of insoluble EuSO₄ during the (NH₄)₂SO₄ leaching step. It is possible that Ce oxidation could have induced the reduction of Eu(III) to Eu(II) during the NaOH pretreatment and/or (NH₄)₂SO₄ leaching steps. The ionic radius of Eu²⁺ ions are larger than that of Eu³⁺ ions. It is also possible that Eu concentration may be low in the monazite sample due to the negative Eu anomaly.

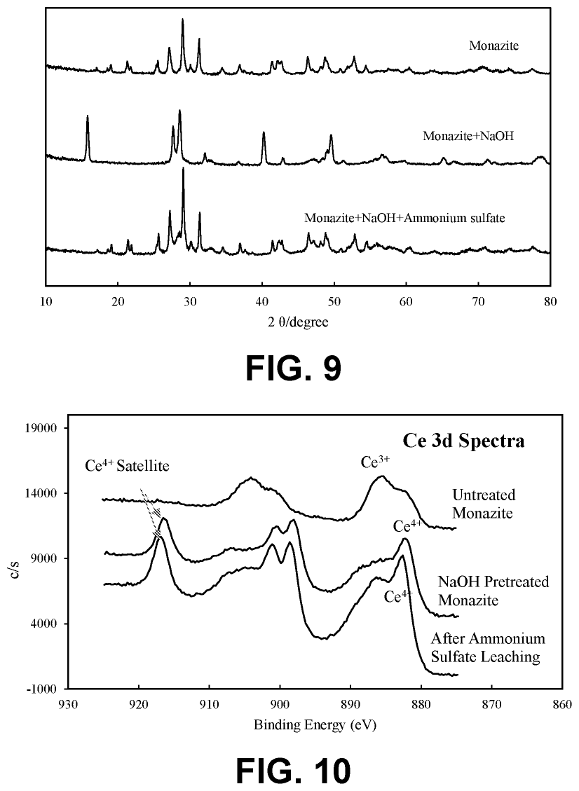

FIG. 9 shows the XRD spectra of the monazite sample before and after the NaOH pretreatment. Also shown is the spectrum of the residue left after the (NH₄)₂SO₄ leaching. The results show that monazite had been converted to rare earth hydroxide (Ln(OH)₃) after the NaOH pretreatment. Note also that after the leaching, most of the hydroxide formed on the monazite surface was removed, leaving the unreacted monazite as a residue.

FIG. 10 shows the XPS spectra of a monazite sample before and after the NaOH pretreatment and the (NH₄)₂SO₄ leaching steps. As shown, the oxidation state of Ce changes from Ce(III) to Ce(IV) as clearly indicated by the satellite peaks at 916.3 eV and 882 eV. It has been reported that CeO₂ or Ce(OH)₄ are sparingly soluble in weakly acidic solutions and dissolved only under aggressive conditions as has also been reported in the literature (Kumari et al., 2019; Li et al., 2017).

### Particle Size

Decomposition of monazite in an NaOH solution is a heterogenous interaction occurring at the solid/liquid interface. The reaction occurs initially on the monazite surface to form a layer of La(OH)₃(s). At steady state, the reaction rate may be controlled by the rate of diffusion of the OH⁻ ions through the product layer. Qi (2018) showed that the decomposition of monazite in NaOH solutions can be modeled using the Valency's equation,

$$1 - \frac{2}{3} R - {( 1 - R )}^{2 / 3} = \frac{2 MDC}{αρ {r}_{0}^{2}} t \qquad [ 5 ]$$

in which R (=1−W/W₀) is the fraction of the mineral reacted with W₀ being the weight of the monazite particle of radius r₀ at time t=0 and W the weight at time t, M and ρ the molecular weight and density of the mineral, D and C the diffusion coefficient and OH⁻ concentration, respectively, α the stoichiometry factor, and ρ being the particle density. Eq. [3] shows that the rate at which monazite decomposes is approximately proportional to the NaOH concentration and is inversely proportional to the square of particle size.

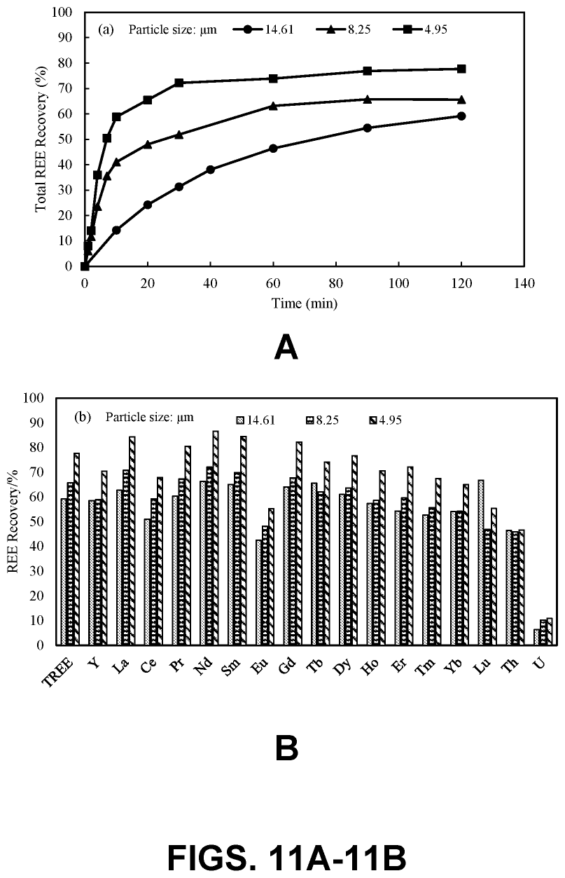

FIG. 11A shows the effects of particle size studied in the present work. As shown, both the kinetics and ultimate REE recoveries increased substantially with decreasing particle size as suggested by Eq. [3]. The kinetics tests were conducted with monazite samples with d₈₀=14.61, 8.25, and 4.95 μm after pretreatments in 50% NaOH solutions at 80° C. for 24 hrs, followed by (NH₄)₂SO₄ leaching at 0.5 M at pH 4 and 25° C. for 2 hrs. As shown in FIG. 11B, the recoveries of the three major elements of monazite, i.e., La, Pr and Nd, were close to 85% at d₈₀=4.95 μm.

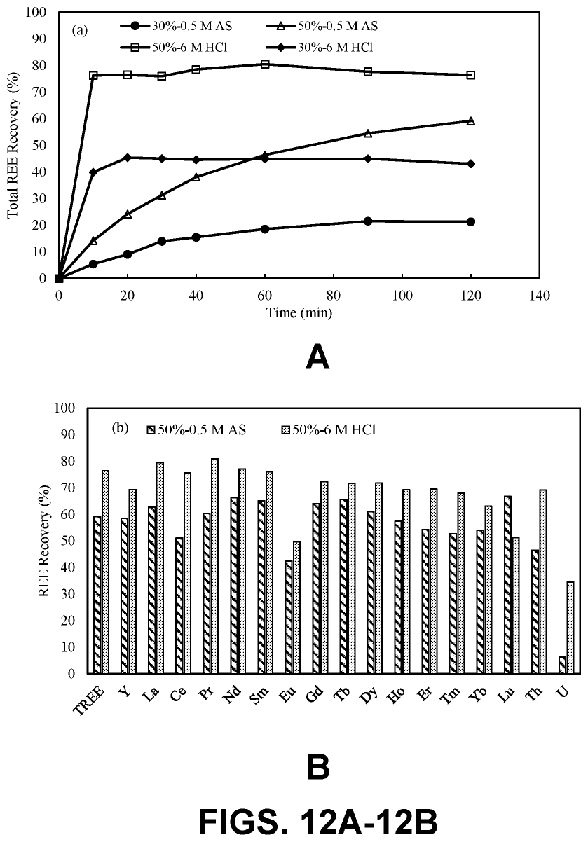

In the present work, the OH⁻ ions displace the PO₄³⁻ ions from the monazite structure and form Ln(OH)₃(s) on the mineral surface, which in turn is leached using (NH₄)₂SO₄ as lixiviant. In the conventional caustic soda leaching process, the Ln(OH)₃(s) is dissolved in HCl solutions at pH in the neighborhood of 3 (Gupta and Krishnaswami, 2015 Qi, 2018). In the present work, a 6 M HCl solution was used to ensure a complete dissolution of the hydroxides formed after 30 and 50% NaOH pretreatments. The results obtained using the two different lixiviants, i.e., (NH₄)₂SO₄ and HCl, are compared in FIG. 12A. As shown, the kinetics of (NH₄)₂SO₄ leaching was slower than that of the HCl leaching. On the other hand, ammonium sulfate leaching released substantially less Th and U extraction into solution, which may be a distinct advantage of using (NH₄)₂SO₄ rather than HCl as lixiviant. This advantage may be attributed to the difference in pH. At the pH where ammonium sulfate leaching was carried out, most of the Th should precipitate out of solution as hydroxide. The results presented in FIGS. 12A and 12B show also that the REE recoveries were higher at the higher NaOH concentration. These results clearly indicate that monazite decomposition by the NaOH pretreatment is critical for achieving high recoveries, while the type of lixiviants used determines the leaching kinetics.

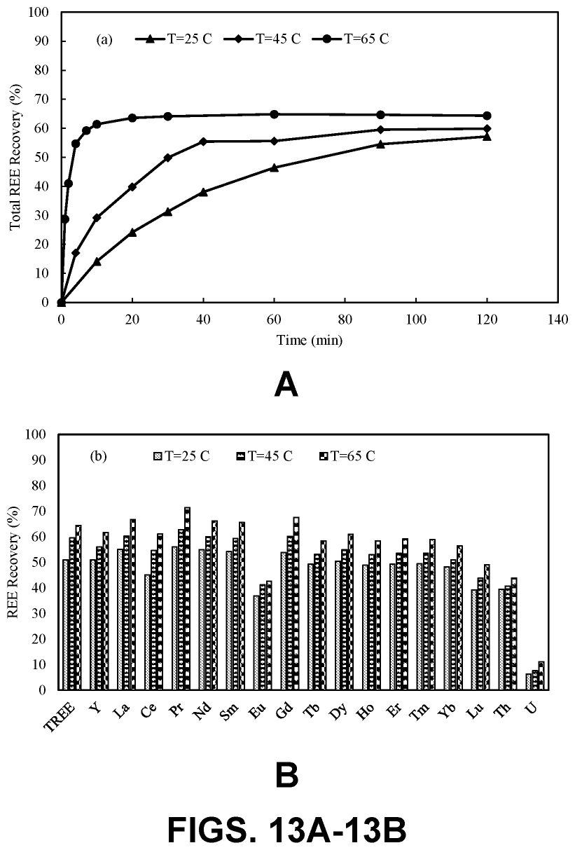

The results presented in FIG. 13A show that the kinetics of the (NH₄)₂SO₄ leaching can be greatly improved by increasing the temperature. At 65° C., the kinetics was as high as that obtained in 6M HCl solution at 25° C. (see FIGS. 13A-13B). Even the ultimate TREE recoveries improved at the higher ammonium sulfate leaching temperature as shown in FIGS. 13A-13B. These improvements were achieved without significantly increasing the release of Th and U into leach liquor.

### Effect of Different Cations

The mechanism by which (NH₄)₂SO₄ can serve as a lixiviant for Ln(OH)₃(s) may be explained by the difference between the hydration enthalpies (ΔH_{hyd}) of NH₄⁺ (−307 KJ/mole) and La³⁺ (−3296 KJ/mole). These and other thermodynamic data used in this section are experimental values reported by Smith (1977). The large difference between the two can serve as a thermodynamic basis for the ion-exchange between the NH₄⁺ ions in solution and the La³⁺ ions, for example, in the vicinity of the Ln(OH)₃(s) surface. Other Ln³⁺ ions also have large negative values of ΔH_{hyd}. In general, the hydration enthalpies of the Ln³⁺ increase with atomic weight due to lanthanide contraction.

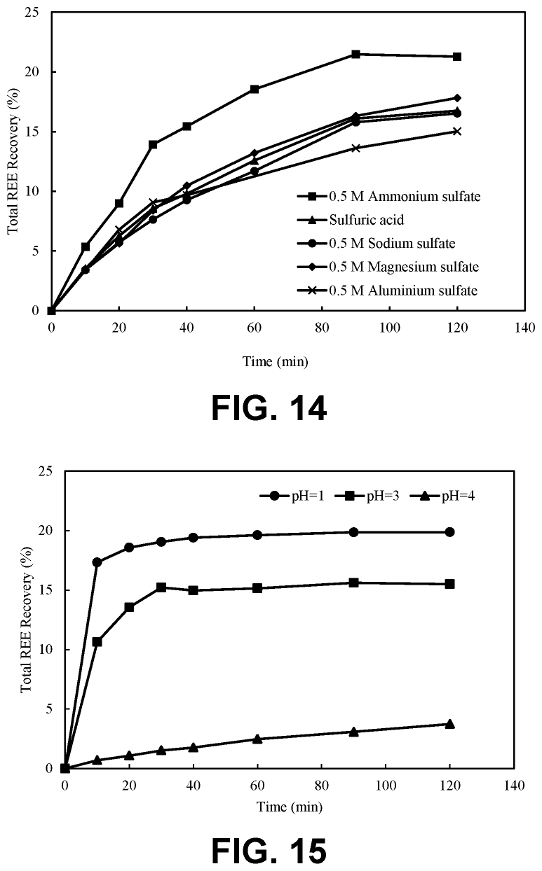

To better understand the role of hydration enthalpies in the Ln(OH)₃(s) leaching, a series of kinetics tests were conducted using sulfate salts of different cations, i.e., H⁺, Na⁺, Mg²⁺, and Al³⁺ ions, with the results presented in FIG. 14 to be compared with those obtained using (NH₄)₂SO₄ as lixiviant. As shown, the NH₄⁺ ions exhibited the fastest leaching kinetics, and the Al³⁺ ions the slowest of the lixiviants tested. This observation may be attributed to the fact that ΔH_{hyd}=−304 J/mole for the NH₄⁺ ions, while ΔH_{hyd}=−4,665 KJ/mole for Al³⁺ ions. The hydration enthalpies for the other cations, i.e., Na⁺, H⁺ and Mg²⁺ ions are −410, −1,190 and −1,920 KJ/mole, respectively, which lied between those for NH₄⁺ and Al³⁺ ions and so were their leaching kinetics (Smith, 1977).

Note here that the H₂SO₄ was used as lixiviant for Ln(OH)₃(s) at pH 4.0, which was probably the reason that the H⁺ ions appeared to have acted as weaker lixiviant than the NH₄⁺ ions. FIG. 15 shows the results obtained using HCl as the sole lixiviant for Ln(OH)₃(s) for comparison in the absence of (NH₄)₂SO₄. As expected, the leaching efficiency increased with decreasing pH. It is interesting, however, that the REE recoveries obtained using (NH₄)₂SO₄ at pH 4 as presented in FIG. 14 tended to be higher than the recoveries obtained using HCl at pH 1 as presented in FIG. 15.

### Effect of Different Anions

FIG. 16 shows the results of using ammonium salts of different anions, i.e., SO₄⁻, HCO₂⁻ and NO₃⁻, as lixiviants. As can be seen, the sulfate performed the best, followed by formate, and nitrate, which was in the same order of the stability constants of the following reactions (Smith et al., 2004; Haas et al., 1995),

$$\begin{matrix}{La}^{3 +} + {SO}_{{4}^{2 -}} \to {LaSO}_{{4}^{+}} & {10}^{3.64}\end{matrix} \qquad [ 6 ]$$

$$\begin{matrix}{La}^{3 +} + {HCOO}^{-} \to {La ( HCOO )}^{2 +} & {10}^{1.74}\end{matrix} \qquad [ 7 ]$$

$$\begin{matrix}{La}^{3 +} + {NO}_{{3}^{-}} \to {LaNO}_{{3}^{2 +}} & {10}^{0.58}\end{matrix} \qquad [ 8 ]$$

The higher the stability constant, the lower the La³⁺ ion concentrations in solution, which will shift the following ion-exchange reaction

$${La}^{3 +} ( surface ) + {NH}_{{4}^{+}} \to {NH}_{{4}^{+}} ( surface ) + {La}^{3 +} \qquad [ 9 ]$$

to the right, and thereby increase the extraction efficiency. The Ln³⁺ ions other than the La³⁺ shown above as an example would behave likewise.

### Discussion

The rare earth extraction process described in the foregoing sections is a two-step process, consisting of decomposition of monazite followed by leaching. In the conventional caustic soda leaching process, essentially lanthanum phosphate (LnPO₄) is converted to lanthanum hydroxide (Ln(OH)₃) before acid leaching. In the present work, we explored the possibility of doing the same under milder conditions, so that the process can be sustainable.

### Decomposition

Being a salt formed between strong acids (Ln³⁺ ions) and a strong base (PO₄³⁻ ions), monazite is extremely stable compounds. Therefore, its decomposition requires an aggressive treatment either in concentrated H₂SO₄ at 200-220° C. or in 60-70% NaOH solutions at 140-180° C. (Lucas et al., 2015). Caustic soda is more expensive than sulfuric acid; therefore, the former is used to decompose monazite concentrates with 55-65% REO, while the latter is used to decompose lower-grade concentrates. Sulfuric acid can deeply penetrate into the mineral matrix and decompose particles of 74-149 μm, while the caustic soda leaching process requires the monazite concentrate be ground to less than 43 μm often to less than 10 μm.

In the present work, the possibility of decomposing monazite under relatively mild conditions at low NaOH concentrations and temperatures was explored. The results showed that monazite can be decomposed at 10⁻³⁰% NaOH concentrations. However, its reaction rate was too slow to be of practical use at the temperature range investigated. It appears that a 50% NaOH may be the minimum required at 80° C. albeit at an extended reaction time. One way to improve the kinetics is to decrease the particle size. At d₈₀=4.95 μm, a total REE recovery of 77.7% has been achieved, with an Nd recovery of 86.5% at 80° C. Decomposing an extremely stable mineral such as monazite would require a high concentration of NaOH, which may be attributed to the relatively small difference in the pK_{b} vales between the PO₄³⁻ ions and OH⁻ ions. Finding a stronger base or efficient chelating agents may lead to the development of a more efficient method of decomposing monazite. Lazo et al. (2017) obtained promising results with combinations of oxalic acid and EDTA as has already been discussed. On the other hand, use of higher concentrations of NaOH is not an insurmountable barrier as the reagent can be readily recycled as is practiced in industry today. Decomposing the mineral at lower temperatures and using (NH₄)₂SO₄ rather than HCl for leaching may provide important benefits.

### Ammonium Sulfate Leaching

It has been shown in the present work that (NH₄)₂SO₄ can be used as a lixiviant for the ion-exchange leaching process represented by Reaction [2]. The driving force for the ion-exchange mechanism may be the difference in the hydration enthalpies between the La³⁺ and NH₄⁺ ions, i.e., −3,285 and −322 KJ/mole, respectively (Moldovenau and Papangelakis, 2012). Thus, the La³⁺ ions have a higher propensity to stay in water than the NH₄⁺ ions.

To better understand the changes in the distribution of the La-bearing species with pH, a species distribution diagram has been constructed for the Ln(OH)₃(s)-water system in FIG. 17 using the thermodynamic data presented in Table 2. As shown, the La³⁺ ion concentration is the highest of all the La-bearing species at the pH range between 3.5 and 7.5. As is well known, the Ln³⁺ ions form outer-sphere complexes with 8-9 water molecules, which will prevent them from being ‘chemosorbed’ to form a complex such as Ln (OH)(s)—O-Ln³⁺. Therefore, only the fully-hydrated outer-sphere complexes may be displaced by the less strongly hydrated cations such as NH₄⁺ ions. Thus, the ion-exchange leaching is favored at pH between 3.5 and 7.5.

TABLE 2
Thermodynamic Data Used for the Solubility
Diagram for La(OH)₃(s)

| | Equilibrium |
|---|---|
| Reactions | constants |
| H₂O ⇄ H⁺ + OH⁻ | 10⁻¹⁴ |
| La(OH)₃(s) ⇄ La³⁺ + 3OH⁻ | 10^{-21.22} |
| La(OH)⁺² ⇄ La³⁺ + OH⁻ | 10^{-5.34} |
| La(OH)₂⁺ ⇄ La³⁺ + 2OH⁻ | 10^{-9.86} |
| La(OH)₃(aq) ⇄ La³⁺ + 3OH⁻ | 10^{-14.09} |
| La₂(OH)₂⁴⁺ ⇄ 2La³⁺ + 2OH⁻ | 10^{-9.59} |
| La(OH)₄⁻ ⇄ La³⁺ + 4OH⁻ | 10^{-15.14} |

(Data sources: Shkolnikov et al., 2009; Lee et al., 1992)

### Ion-Exchange Leaching Model

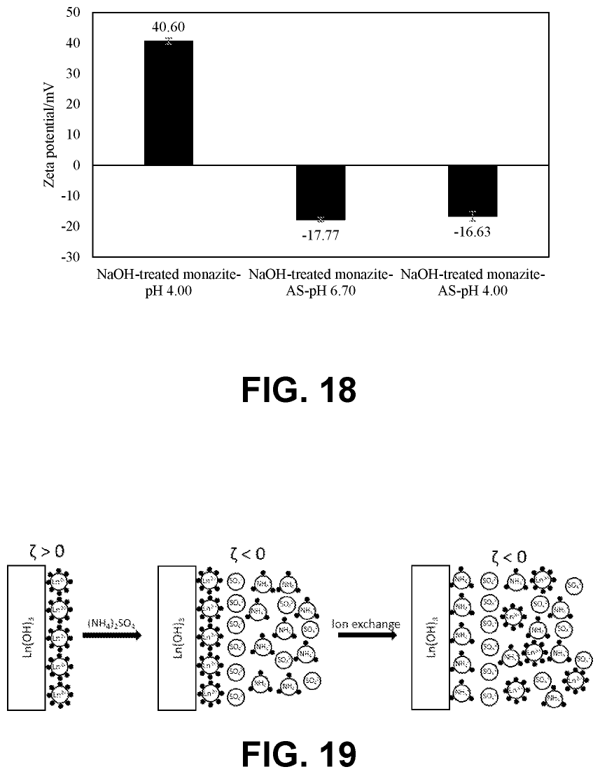

When monazite is pretreated by NaOH and subsequently by (NH-₄)₂SO₄, the ζ-potentials of the mineral and its reaction products will change. Therefore, a series of ζ-potential measurements have been conducted, with the results presented in FIG. 18. At pH 4, the ζ-potential of NaOH-treated monazite was 40.60 mV due to the out-sphere Ln³⁺ complexes adsorbed on the Ln(OH)₃(s) surface. When the NaOH-treated monazite was contacted with (NH₄)₂SO₄, the ζ-potential dropped to −17.77 mV at pH 6.7 most probably due to the adsorption of the SO₄²⁻ ions to the outer-sphere Ln³⁺ complexes adsorbed on the hydroxide surface. As the pH decreased to 4.0, the ζ-potential became slightly less negative due to the displacement of the Ln³⁺ complexes by the NH₄⁺ ion.

Based on the ζ-potential data presented in FIG. 18, a model for an ion-exchange leaching mechanism is proposed as depicted in FIG. 19. The ζ-potential of the Ln(OH)₃(s) surface formed as a result of the NaOH pretreated of monazite is positive at pH 4 due to the adsorption of the outer-space Ln³⁺ complexes. As the (NH₄)₂SO₄ lixiviant is added to the system, SO₄²⁻ ions adsorb to the positively charged surface possibly to the Stern-layer, with the NH₄⁺ and SO₄²⁻ ions forming diffuse double-layers. The SO₄²⁻ ions preferentially adsorbed to the Stern layer should provide a screening effect and make it easier for the NH₄⁺ ions to displace the Ln³⁺ ions via the ion-exchange mechanism represented by Reaction [2].

As has already been discussed, the driving force for the ion-exchange leaching should be the difference in enthalpy of hydration. Increasing the (NH₄)₂SO₄ concentrations should help increase the leaching due to increased chemical potential. That the ζ-potentials remain more or less constant may a typical example of ion-exchange reaction

### Summary and Conclusion

Extracting rare earth elements from monazite requires aggressive conditions due to the extreme stability of the mineral. Possibilities of decomposing it under milder conditions have been explored. The results obtained in the present work showed that extracting rare earths at temperatures below 100° C. is possible albeit at extended reaction times. It is difficult, however, to substantially decompose the mineral at NaOH concentrations below 50%, a problem that can be resolved by recycling the spent alkali as is being practiced in industry. It has been demonstrated that monazite can be decomposed at a temperature of 80° C. or lower, followed by ammonium sulfate leaching to save energy and minimize waste water generation using ammonium sulfate as lixiviant for the extraction of REEs from the lanthanide hydroxides produced as a result of monazite decomposition. Experimental data showed that ammonium sulfate may be a better lixiviant than hydrochloric acid, which may be attributed to the fact that the hydration enthalpy of ammonium ions is less negative than that of the hydronium ions. On the other hand, the kinetics of the ammonium sulfate leaching was slower than that of the acid leaching. However, the kinetics of the former increased sharply at higher temperatures.

Based on the ζ-potential measurements conducted on the monazite samples treated with the reagents used in the present work, an ion-exchange leaching model has been developed. According to the model, sulfate ions provide a screening effect such that ammonium ions can more readily approach the Ln(OH)₃(s) coated with the Ln³⁺ ions and release them into solution. The solubility diagram for the hydroxide shows that the Ln³⁺ ion concentration reaches a maximum at pH 4, at which the ion-exchange leaching is found to be most efficient. The proposed model suggests ways to further improve the ion-exchange leaching process.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### REFERENCES

Bell, D. (2019). Novel Approaches to Extracting Rare Earth Elements and Critical Materials from Coal and Coal Byproducts. Proposal submitted to DUE in response to DE-FOA-0002003, Jun. 10, 2019; Yoon, R. H., Co-Principal Investigator.
Bern, C. R., Yesavage, T., & Foley, N. K. (2017). Ion-adsorption REEs in regolith of the Liberty Hill pluton, South Carolina, USA: An effect of hydrothermal alteration. Journal of Geochemical Exploration, 172, 29-40.
Birk, D., & White, J. C. (1991). Rare earth elements in bituminous coals and underclays of the Sydney Basin, Nova Scotia: Element sites, distribution, mineralogy. International Journal of Coal Geology, 19 (1-4), 219-251.
Bryan, R. C., Richers, D., Andersen, H. T., & Gray, T. (2015). Assessment of rare earth elemental contents in select United States coal basins. United States National Energy Technology Laboratory.
Eskenazy, G. (1978). Rare-earth elements in some coal basins of Bulgaria. Geologica Balcanica, 8 (2), 81-88.
Eskenazy, G. M. (1987). Rare earth elements in a sampled coal from the Pirin deposit, Bulgaria. International Journal of Coal Geology, 7 (3), 301-314.
Foley, N. K., Ayusor, A., Bern, C. R., Hubbard, B. E., & Vazquez, J. A. (2014). REE Distribution and Mobility in Regolith Formed on Granite Bedrock of the Southeast United States. Acta Geologica Sinica-English Edition, 2 (88), 428-430.
Foley, N. K., Bern, C. R., Ayuso, R. A., Hubbard, B. E., & Shah, A. K. (2015). Geochemical and mineralogical characteristics of REE in granite-derived regolith: a model for the southeast United States. In 13th Biennial Society for Geology Applied to Ore Deposits.
Gupta, C. K. and Krishnamurthy, N., Extractive Metallurgy of Rare Earth, CRC Press, 2005.Moldoveanu, G. A., & Papangelakis, V. G. (2012). Recovery of rare earth elements adsorbed on clay minerals: I. Desorption mechanism. Hydrometallurgy, 117, 71-78.
Penn, C. J., & Warren, J. G. (2009). Investigating phosphorus sorption onto kaolinite using isothermal titration calorimetry. Soil Science Society of America Journal, 73 (2), 560-568.
Renton, J. J., Cecil, C. B., Stanton, R., & Dulong, F. (1979). Compositional relationships of plants and peats from modern peat swamps in support of a chemical coal model. Carboniferous coal, short course and guidebook, 3, 57-102.
Renton, J. J. (1982). Mineral matter in coal. In Coal structure (pp. 283-326). Academic Press New York.
Rozelle, P. L., Khadilkar, A. B., Pulati, N., Soundarrajan, N., Klima, M. S., Mosser, M. M., & Pisupati, S. V. (2016). A study on removal of rare earth elements from US coal byproducts by ion exchange. Metallurgical and Materials Transactions E, 3 (1), 6-17.
U.S. Department of the Interior & U.S. Geological Survey (2020). Mineral Commodity Summaries 2020.
Yang, X. J., Lin, A., Li, X. L., Wu, Y., Zhou, W., & Chen, Z. (2013). China's ion-adsorption rare earth resources, mining consequences and preservation. Environmental Development, 8, 131-136.
Yoon, R. H. (2012). Critical Materials Energy Innovation Hub. Proposal submitted in response to Funding Opportunity Number DE-FOA-0000687, U.S. Department of Energy.
Sanematsu K., Kon, Y., Imai, A., “Influence of Phosphate on Mobility and Adsorption of REEs during Weathering of Granite in Thailand,” J. Asian Earth Science, 111 (2015) 14-30.
Krishnamurthy, N. and Gupta, C. K., 2015. Extractive metallurgy of rare earths. CRC press.
Dezhi Qi. 2018. Hydrometallurgy of Rare Earths: Extraction and Separation. Elsevier Inc.
O'Driscoll, M., 1991. An overview of rare earth minerals supply and applications. In Materials Science Forum (Vol. 70, pp. 409-420). Trans Tech Publications Ltd.
Morrison, W. M., 2019. Trade Dispute with China and Rare Earth Elements. Congressional Research Service.
Van Gosen, B. S., Verplanck, P. L. and Emsbo, P., 2019. Rare earth element mineral deposits in the United States (No. 1454). US Geological Survey.
Lazo, D. E., Dyer, L. G., Alorro, R. D. and Browner, R., 2020. Observations of the varied reactivity of xenotime and monazite in multiple systems. Minerals Engineering, 159, p.106633.
Abdel-Rehim A M. An innovative method for processing Egyptian monazite. Hydrometallurgy. 2002 Dec. 1; 67 (1-3): 9-17.
Kim, W., Bae, I., Chae, S. and Shin, H., 2009. Mechanochemical decomposition of monazite to assist the extraction of rare earth elements. Journal of Alloys and compounds, 486 (1-2), pp. 610-614.
Cen, P., Bian, X., Liu, Z., Gu, M., Wu, W. and Li, B., 2021. Extraction of rare earths from bastnaesite concentrates: A critical review and perspective for the future. Minerals Engineering, 171, p. 107081.
Zhu, Z., Pranolo, Y. and Cheng, C. Y., 2015. Separation of uranium and thorium from rare earths for rare earth production-A review. Minerals Engineering, 77, pp. 185-196.
Lapidus, G. T. and Doyle, F. M., 2015. Selective thorium and uranium extraction from monazite: I. Single-stage oxalate leaching. Hydrometallurgy, 154, pp. 102-110.
Lazo, D. E., Dyer, L. G., Alorro, R. D. and Browner, R., 2017. Treatment of monazite by organic acids I: Solution conversion of rare earths. Hydrometallurgy, 174, pp. 202-209.
Amer, T. E., El-Sheikh, E. M., Gado, M. A., Abu-Khoziem, H. A. and Zaki, S. A., 2018. Selective recovery of lanthanides, uranium and thorium from Rosetta monazite mineral concentrate. Separation Science and Technology, 53 (10), pp. 1522-1530.
Larijani, C., Schwendner, P., Cockell, C., Ivanov, P., Russell, B., Aitken-Smith, P., Pearce, A. K. and Regan, P. H., 2017. Destructive and non-destructive measurements of NORM in monazite-rich sands of Brazil. Radiation Physics and Chemistry, 140, pp. 180-185.
Panda, R., Kumari, A., Jha, M. K., Hait, J., Kumar, V., Kumar, J. R. and Lee, J. Y., 2014. Leaching of rare earth metals (REMs) from Korean monazite concentrate. Journal of Industrial and Engineering Chemistry, 20 (4), pp. 2035-2042.
Archana Kumar et al. Advanced process to dephosphorize monazite for effective leaching of rare earth metals (REMs) Hydrometallurgy 187 (2019) 203-211.
Mei Li et al. Effect of oxidation behavior of cerium during the roasting process on the leaching of mixed rare earth concentrate. Hydrometallurgy 174 (2017) 156-166.
Smith, D. W., 1977. Ionic hydration enthalpies. Journal of Chemical Education, 54 (9), p.540.
Smith, R. M., Martell, A. E. and Motekaitis, R. J., 2004. NIST standard reference database 46. NIST Critically Selected Stability Constants of Metal Complexes Database Ver, 2.
Haas, J. R., Shock, E. L. and Sassani, D. C., 1995. Rare earth elements in hydrothermal systems: estimates of standard partial molal thermodynamic properties of aqueous complexes of the rare earth elements at high pressures and temperatures. Geochimica et Cosmochimica Acta, 59 (21), pp. 4329-4350.
Lucas, J., Lucas, P., Le Mercier, T., Rollat, A. and Davenport, W. G., 2014. Rare earths: science, technology, production and use. Elsevier.
Shkol'nikov, E. V., 2009. Thermodynamic characterization of the amphoterism of hydroxides and oxides of scandium subgroup elements in aqueous media. Russian Journal of Applied Chemistry, 82 (12), pp. 2098-2104.
Lee, J. H. and Byrne, R. H., 1992. Examination of comparative rare earth element complexation behavior using linear free-energy relationships. Geochimica et Cosmochimica Acta, 56 (3), pp. 1127-1137.
Borst, A. M., Smith, M. P., Finch, A. A., Estrade, G., Villanova-de-Benavent, C., Nason, P., Marquis, E., Horsburgh, N. J., Goodenough, K. M., Xu, C. and Kynický, J., 2020. Adsorption of rare earth elements in regolith-hosted clay deposits. Nature communications, 11 (1), pp. 1-15.
G. A. Moldoveanu, V. G. Papangelakis. Recovery of rare earth elements adsorbed on clay minerals: I. Desorption mechanism. Hydrometallurgy 117-118 (2012) 71-78.
Foley, N., & Ayuso, R. (2015a). REE enrichment in granite-derived regolith deposits of the Southeastern United States: prospective source rocks and accumulation processes. Geol. Surv. Pap, 3, 131-138.
Foley, N., Ayuso, R., Hubbard, B., Bern, C., & Shah, A. (2015b). Geochemical and mineralogical characteristics of REE in granite derived regolith of the Southeastern United States. In Mineral resources in a sustainable world. Proceedings of the 13th Biennial SGA Meeting (Vol. 2, pp. 725-729).
Borst, A. M., Smith, M. P., Finch, A. A., Estrade, G., Villanova-de-Benavent, C., Nason, P., . . . & Geraki, K. (2020). Adsorption of rare earth elements in regolith-hosted clay deposits. Nature Communications, 11 (1), 1-15.
Foley, N., & Ayuso, R. (2015a). REE enrichment in granite-derived regolith deposits of the Southeastern United States: prospective source rocks and accumulation processes. Geol. Surv. Pap, 3, 131-138.
Foley, N., Ayuso, R., Hubbard, B., Bern, C., & Shah, A. (2015b). Geochemical and mineralogical characteristics of REE in granite derived regolith of the Southeastern United States. In Mineral resources in a sustainable world. Proceedings of the 13th Biennial SGA Meeting (Vol. 2, pp. 725-729).
Borst, A. M., Smith, M. P., Finch, A. A., Estrade, G., Villanova-de-Benavent, C., Nason, P., . . . & Geraki, K. (2020). Adsorption of rare earth elements in regolith-hosted clay deposits. Nature Communications, 11 (1), 1-15.

1. A method for extracting one or more rare earth elements from rare earth element source comprising
a. admixing the rare earth element source in water with a base at temperature less than or equal to 100° C. to produce a first composition;
b. admixing the first composition with an electrolyte composition comprising a plurality of cations, anions, or a combination thereof to produce a second composition; and
c. extracting the rare earth elements from the second composition.

2. The method of claim 1, wherein the second composition has a pH in the range of about 3 to about 10.

3. The method of claim 1, wherein the base comprises an alkali metal and/or ammonium hydroxide.

4. The method of claim 1, wherein the base comprises sodium hydroxide, potassium hydroxide, sodium carbonate, lime, or any combination thereof.

5. The method of claim 1, wherein the base is from about 5% to about 80% by volume of the first composition.

6. The method of claim 1, wherein the base is from about 10% to about 50% by volume of the first composition.

7. The method of claim 1, wherein the rare earth element source is admixed with the base from about 0.5 hours to about 48 hours.

8. The method of claim 1, wherein the electrolyte composition comprises ammonium ions, aluminum ions, magnesium ions, sodium ions, cadmium ions, or any combination thereof.

9. The method of claim 1, wherein the electrolyte composition comprises sulfate ions, nitrate ions, formate ions, carbonate ions, bicarbonate ions, chloride ions, or any combination thereof.

10. The method of claim 1, wherein the electrolyte composition comprises ammonium sulfate, aluminum sulfate, magnesium sulfate, sodium chloride, ammonium formate, ammonium nitrate, or any combination thereof.

11. The method of claim 1, wherein the electrolyte composition comprises a chelating agent, a complexing agent, or a combination thereof.

12. The method of claim 11, wherein the chelating agent comprises a phosphoric acid, an organic acid, a diamine, a polyamine, a hydroxamic acid, a polyol, a sulfonic acid, or any combination thereof.

13. The method of claim 1, wherein the electrolyte composition is admixed with the rare earth element source at a pH of from about 3.5 to about 7.5.

14. The method of claim 1, wherein the rare earth element source is admixed with the electrolyte composition at a temperature less than or equal to 100° C.

15. The method of claim 1, wherein the rare earth element source is admixed with the electrolyte composition at a temperature from about 40° C. to less than or equal to 100° C.

16. The method of claim 1, wherein the rare earth element source is pulverized prior to step (a).

17. The method of claim 1, wherein the rare earth element source has an average particle size of less than about 100 μm.

18. The method of claim 1, wherein the rare earth elements are extracted by leaching.

19. The method of claim 1, wherein the rare earth element source comprises a clay material.

20. The method of claim 19, wherein the clay material comprises a coal byproduct.

21. The method of claim 20, wherein the coal byproduct comprises an underclay, partings, a shale, a tonstein, or an overburden.

22. The method of claim 1, wherein the rare earth element source comprises monazite, apatite, xenotime, bastnasite, ion-adsorption clays, secondary phosphate minerals, or any combination thereof.

23. The method of claim 1, wherein the rare earth element source comprises a rare earth metal salt.

24. The method of claim 1, wherein the rare earth element source comprises a rare earth phosphate, carbonate, fluorocarbonate, oxide, hydroxide, or oxyhydroxide.

25. The method of claim 1, wherein the rare earth element source is derived from fine coal refuse.

26. The method of claim 1, wherein the rare earth element that is isolated comprises a rare earth element metal ionic compound.

27. The method of claim 1, wherein the rare earth element that is isolated comprises a rare earth element salt, a rare earth element hydroxide, a rare earth element oxide, or a combination thereof.

28. The method of claim 1, wherein the rare earth element comprises Ce, Nd, La, Sm, Pr, Gd, Dy, Y, Sc, or any combination thereof.

29. The method of claim 1, wherein the process is conducted by a continuous process.

30. The method of claim 1, wherein the process is conducted by a batch process.

31. The method of claim 1, wherein prior to step (a), the rare earth element source is subjected to one or more physical separation processes to separate one or more rare earth-bearing minerals and ion-adsorption clays from the rare earth element source.

32. The method of claim 31, where in the rare earth mineral comprises monazite, apatite, xenotime, bastnasite, an ion-adsorption clay, secondary phosphate minerals, or any combination thereof.

33. The method of claim 1, wherein the base is from about 1% to about 50% by volume of the first composition and the electrolyte is lixiviant.

34. The method of claim 33, wherein the base is sodium hydroxide.

35. A method for extracting one or more rare earth elements from fine coal refuse comprising coal fines, clayey materials, and rare earth minerals using the method comprising
a. extracting salable coal fines from the clayey materials and the rare earth minerals;
b. separating the clayey material from the rare earth materials; and
c. extracting the rare earth elements from the clayey materials using the method in any one of claims 1 to 34 with or without separating the rare earth minerals.

36. A method of extracting one or more rare earth elements from the naturally occurring rare earth phosphates using the method in any one of claims 1 to 34.

37. A method of extracting one or more rare earth elements from a rare earth element source using a complexing agent to decrease the activity of lanthanide ions and thereby increase the solubility of the rare earth element source in water.

38. A method for extracting one or more rare earth elements from a rare earth element source comprising
a. admixing the rare earth element source in water with an electrolyte composition comprising a plurality of cations, anions, or a combination thereof at temperature less than or equal to 100° C. to produce a first composition;
b. admixing the first composition with a base to produce a second composition; and
c. extracting the rare earth elements from the second composition.

39. A method for extracting one or more rare earth elements from a rare earth element source comprising
a. admixing the rare earth element source in water with (i) a base and (ii) an electrolyte composition comprising a plurality of cations, anions, or a combination thereof at temperature below 100° C. to produce a first composition; and
b. extracting the rare earth elements from the first composition.

40. A method for extracting one or more rare earth elements from a rare earth element source comprising
a. admixing the rare earth element source in water with an electrolyte composition comprising a plurality of cations, anions, or a combination thereof at temperature below 100° C. to produce a first composition; and
b. extracting the rare earth elements from the first composition.

41. A method of extracting rare earth elements from the clayey materials isolated from coal byproducts comprising the following steps,
a. pretreatment with a 1 to 10% NaOH solution in the presence of a chelating agent to decompose the passivated forms of rare earth elements,
b. extracting the rare earth elements into solution using a lixiviant.

42. A method of extracting rare earth elements from the clayey materials isolated from coal byproducts comprising the following steps,
a. pretreatment in a 1 to 10% NaOH solution to decompose the rare earth phosphate formed during coal formation, and
b. allow the rare earth elements to be extracted into solution using a lixiviant.
